(19) United States
(12) Patent Application Publication
(10) Pub. No.: US 2024/0400793 A1
(43) Pub. Date: Dec. 5, 2024

(54) COMPOSITION FOR POLYURETHANE FOAM, FOAM PREPARED THEREFROM AND A METHOD THEREOF

(71) Applicant: Momentive Performance Materials Inc., Niskayuna, NY (US)

(72) Inventors: Mary MA, Shanghai (CN); Joshi KAUSTUBH, Karnataka (IN); Gnuni KARAPETYAN, Leverkusen (DE); Karthik RAJENDRAN, Bangalore (IN); Karthikeyan SIVASUBRAMANIAN, Bangalore (IN); Petr KOUTNIK, Marietta, OH (US); Madhusudhan SRINIVASAN, Chennai (IN)

(21) Appl. No.: 18/687,835

(22) PCT Filed: Aug. 31, 2022
(86) PCT No.: PCT/US2022/042112

§ 371 Date: Feb. 29, 2024

(30) Foreign Application Priority Data
Aug. 31, 2021 (IN) 202111039327

(51) Int. Cl. C08K 5/53; C08K 5/13; C08K 5/3445; C08K 5/39; C08K 5/50; C08K 5/524

(52) U.S. Cl. CPC C08K 5/53; C08K 5/13; C08K 5/3445; C08K 5/39; C08K 5/50; C08K 5/524

(57) ABSTRACT

A composition and method for preparing a polyurethane foam. The composition comprises at least one emission control agent. In embodiments, the composition comprises at least one emission control agent selected from the group consisting of (i) a phosphorous containing group; (ii) a thiocarbamate; (iii) a nitrogen containing compound; (iv) a phenolic antioxidant; or a combination of two or more thereof. The invention also relates to a method of controlling the emission of at least one aldehyde species in a raw material employed in the foam composition or that may be produced during the foam forming or foam curing or foam aging process.

### CROSS-REFERENCE TO RELATED APPLICATIONS

This application claims priority to and the benefit of India Provisional Application No. 20/2111039327 filed on Aug. 31, 2021, the disclosure of which is incorporated herein by reference in its entirety.

### FIELD OF INVENTION

The present invention relates to a composition for polyurethane foam (PU), a polyurethane foam prepared from the composition and a method of preparation of such foam. In particular, the invention relates to a composition of polyurethane foams that offers reduced emissions and, consequently, undesirable odor.

### BACKGROUND

Polyurethane foams are well known for their wide variety of applications. Conventionally, volatile organic compounds (VOC) are emitted from such foams, and include, for example, low molecular weight volatile aldehydes and amines that are either present in the raw materials used for producing the foams or are produced during the foaming process or result from aging and may contribute to odor and emission profiles in consumer products prepared from such foams. Examples of such low molecular weight aldehydes include formaldehyde, acetaldehyde, propionaldehyde, and acrolein.

Attempts have been made in the past to provide materials that are used as additives in polyurethane foams to remove emissions of volatile compounds contributing to automotive cabin interiors. Such materials can be provided as part of a separate device, e.g., an air purification device in a car interior, home, building, combustion heater, baggage, furniture, etc.

### SUMMARY

The following presents a summary of this disclosure to provide a basic understanding of some aspects concerning VOC emissions from certain PU foam compositions. This summary is intended to neither identify key or critical elements nor define any limitations of embodiments or claims. Furthermore, this summary may provide a simplified overview of some aspects that may be described in greater detail in other portions of this disclosure.

In one aspect, provided is a composition for preparing polyurethane foam, the composition comprising at least one compound suitable for controlling the emission of one or more volatile compounds. In particular, provided is a composition comprising at least one compound that may control the emission of at least one aldehyde species in a raw material employed in the foam composition or that may be produced during the foam forming or foam curing or foam aging process.

In another aspect, provided is a method of preparing a polyurethane foam from this composition.

In one aspect, provided is a composition comprising: (a) at least one foam reactant, (b) at least one emission control agent selected from the group consisting of (i) a phosphorous containing group: (ii) a thiocarbamate: (iii) a nitrogen containing compound: (iv) a phenolic antioxidant; or a combination of two or more thereof; and (c) a catalyst.

In one embodiment, the at least one emission control agent comprise the phosphor containing group (i) selected from a phosphite triester, diorganophosphite, organodiphosphites, a polyolefin having a phosphite substituent, a phosphonate having a CH or CH₂ moiety attached to phosphorous, a phosphonium compound, a phosphazene.

In one embodiment, the at least one emission control agent is selected from one or more of a compound of Formula (I), Formula (II), (V-i), (V-ii), (V-iii): (V-iv), (V-v), and/or (V-vi):

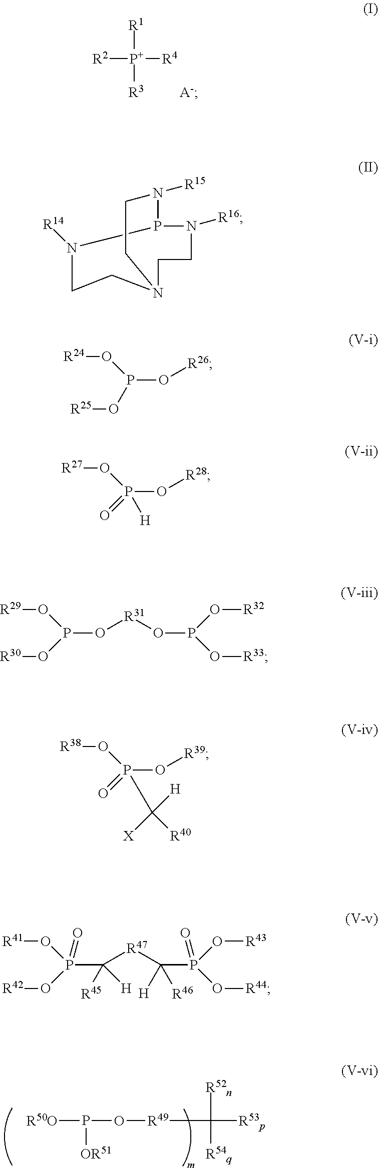

where R¹ is selected from a C6-C30 aryl, or —N(R⁵) R⁶, where R⁵ and R⁶ are each independently selected from hydrogen, monovalent organic groups, monovalent heteroorganic groups (for example, comprising nitrogen, oxygen, phosphorus, silicon, or sulfur in the form of groups or moieties that are preferably bonded through a carbon atom and that do not contain acid functionality such as carboxylic or sulfonic), and combinations thereof, or R⁵ and R⁶ can be taken together to form a 5-10 membered ring:

R² is selected from a C6-C30 aryl, —N(R⁵) R⁶, and —OR⁷, where R⁵ and R⁶ are each independently selected from hydrogen, monovalent organic groups, monovalent heteroorganic groups (for example, comprising nitrogen, oxygen, phosphorus, silicon, or sulfur in the form of groups or moieties that are preferably bonded through a carbon atom and that do not contain acid functionality such as carboxylic or sulfonic), and combinations thereof, or R⁵ and R⁶ can be taken together to form a 5-10 membered ring, and R⁷ is selected from a C1-C10 alkyl:

R³ is selected from a C6-C30 aryl, —N(R⁵) R⁶, and —OR⁸, where R⁵ and R⁶ are each independently selected from hydrogen, monovalent organic groups, monovalent heteroorganic groups (for example, comprising nitrogen, oxygen, phosphorus, silicon, or sulfur in the form of groups or moieties that are preferably bonded through a carbon atom and that do not contain acid functionality such as carboxylic or sulfonic), and combinations thereof, or R⁵ and R⁶ can be taken together to form a 5-10 membered ring, and R⁸ is selected from a C1-C10 alkyl:

R⁴ is selected from —CH₂—R⁹ or ═N—R¹⁰, where R⁹ is selected from —C(O)—OₓR¹¹, —CN, —R¹²CN, or —R¹³—CH₂—PR¹R²R³, where R¹¹ is H, a C1-C10 alkyl, a C1-C10 alcohol, or a C1-C10 alkoxy: R¹² and R¹³ ae each selected from a C1-C10 alkyl or a C6-C30 aryl, x is 0 or 1, and R¹, R², and R³ are as described above; and R¹⁰ is selected from a C1-C10 alkyl or a C6-C30 aryl:

A⁻ is selected from an organic or inorganic anion, with the proviso that when R⁴ is ═N—R¹⁰, the P atom in Formula (I) is pentavalent and does not have a positive charge and no counter A: where R¹⁴, R¹⁵, and R¹⁶ are each independently chosen from hydrogen, monovalent organic groups, monovalent heteroorganic groups, and combinations thereof:

where R²⁴, R²⁵, R²⁶, R²⁷, R²⁸ R²⁹, R³⁰, R³², R³³, R³⁸, R³⁹, R⁴¹, R⁴², R⁴³, R⁴⁴, R⁵⁰, and R⁵¹ are each independently selected from a monovalent C1-C30 alkyl, a C2-C30 alkene comprising one or more points of unsaturation, a C4-C30 cycloalkyl, a C2-C30 ether group a C2-C30 alkylene glycol, a C2-C30 polyalkylene glycol, a C6-C30 aryl, a C7-C30 arylalkyl, and a C7-C30 alkylaryl:

R³¹, R⁴⁷, and R⁴⁹ are each independently selected from a C1-C30 alkylene, a C4-C30 cycloalkylene, a C6-C30 arylene, a C7-C30 arylalkylene, and a C7-C30 alkylarylene:

R⁴⁰, R⁴⁵, R⁴⁶, R⁵², R⁵³, and R⁵⁴ are each independently selected from hydrogen, a monovalent C1-C30 alkyl, a C2-C30 alkene comprising one or more points of unsaturation, a C4-C30 cycloalkyl, a C2-C30 ether group, a C6-C30 aryl, a C7-C30 arylalkyl, and a C7-C30 alkylaryl; and

X is C(O)—R⁴⁸, a C1-C30 alkyl, a C6-C30 aryl optionally substituted with a cyano, OH, where R⁴⁸ is selected from a C1-C30 alkyl . . .

In one embodiment, the emission control agent is selected from a compound of formula (I), where R¹, R², and R³ are each independently selected from a C6-C30 aryl, and R⁴ is selected from —CH₂—R⁹: ═N—R¹⁰: where R⁹ is selected from —C(O)—OₓR¹¹, —CN, or —R¹²CN; R¹¹ is a C1-C10 alkyl, a C1-C10 alcohol, or a C1-C10 alkoxy: R¹² is selected from a C1-C10 alkyl or a C6-C30 aryl; and x is 0 or 1.

In one embodiment, the emission control agent is selected from a compound of formula (I), where R¹, R², and R³ are each independently selected from —N(R⁵) R⁶ where R⁵ and R⁶ are each independently a C1-C10 alkyl group; and R⁴ is selected from ═N—R¹⁰ where R¹⁰ is selected from a C1-C10 alkyl or a C6-C30 aryl.

In one embodiment, the emission control agent is selected from a compound of formula (I), where R¹ is R² is —OR⁷: R³ is —OR⁸: where R⁷ and R⁸ are each independently a C1-C10 alkyl; R⁴ is —CH₂—R⁹ where R⁹ is selected from —C(O)—OₓR¹¹, where R¹¹ is H, a C1-C10 alkyl, a C1-C10 alcohol, or a C1-C10 alkoxy.

In one embodiment, the emission control agent is selected from a compound of formula (II), and where R¹⁴, R¹⁵, and R¹⁶ are each selected from a C1-C10 alkyl. In one embodiment, R¹⁴, R¹⁵, and R¹⁶ are each methyl.

In one embodiment, the emission control agent is selected from one or more of (cyanomethyl)-triphenylphosphonium chloride, (methoxycarbonylmethyl)-triphenylphosphonium bromide, tert-buty limino-tris(dimethylamino)phosphorene (phosphazene base P1-t-Bu), tert-butylimino-tri (pyrrolidino)phosphorane [phosphazene base P1-t-Bu-tris(tetramethylene)], tert-octylimino-tris(dimethylamino)phosphorane (phosphazene base P1-t-Oct), 2,8,9-trimethyl-2,5,8,9-tetraaza-1-phosphabicyclo[3.3.3]undecane, 2,8,9-triisopropyl-2,5,8,9-tetraaza-1-phosphabicyclo[3.3.3]undecane, 2,8,9-triisobutyl-2,5,8,9-tetraaza-1-phosphabicyclo[3.3.3]undecane, 3,9-bis(octadecyloxy)-2,4,8,10-tetraoxa-3,9-diphosphaspiro [5.5]undecane, 4,4′-bis(diethylphosphonomethyl) biphenyl, diethyl-4-cyano benzyl phosphonate, N-methoxy-N-methyl(triphenylphosphoranylidene) acetamide, dimethyl(2-oxopropyl)phosphonate, diethyl(2-oxopropyl)phosphonate, dimethyl(2-oxoheptyl)phosphonate, diethyl(2-oxoheptyl)phosphonate, diethyl carboxymethylphosphonate, diethyl(2-oxo-2-phenylethyl)phosphonate, diethyl (methylthiomethyl)phosphonate, methyl(triphenylphosphoranylidene) acetate, diethylphosphonoacetic acid, and 9,10-dihydro-9-oxo-10-phosphophenanthrene-10-oxide.

In one embodiment, the emission control agent comprises a phosphite triester of the formula (V-i) where R²⁴, R²⁵ and R²⁶ are each a C1-C30 alkyl. In one embodiment, R²⁴. R²⁵, and R²⁶ are selected from methyl, ethyl, propyl, isopropyl, butyl, isobutyl, tertbutyl, pentyl, isopentyl, hexyl, isohexyl, heptyl, isoheptyl, ocytl, isooctyl, nonyl, decyl, isodecyl, dodecyl, isododecyl, tridecyl, isotridecyl, lauryl, and 2-ethylhexyl.

In one embodiment, the emission control agent comprises a phosphite of the formula (V-i) where R²⁴, R²⁵, and R²⁶ are each a C6-C30 aryl, a C7-C30 arylalkyl, or a C7-C30 alkylaryl. In one embodiment, R²⁴, R²⁵, and R²⁶ are selected from phenyl, tosyl, methylphenyl, 6-tertbutyl-3-methylphenyl.

In one embodiment, the emission control agent comprises a phosphite triester of the formula (V-i) where R²⁴, R²⁵ and R²⁶ are each a C2-C30 alkylene glycol or C2-C30 polyalkylene glycol. In one embodiment, R²⁴, R²⁵ and R²⁶ are each selected from ethylene glycol, propylene glycol, diethylene glycol, dipropylene glycol, triethylene glycol, or tripropylene glycol, the emission control agent comprises a diorganophosphite of the formula (V-ii) or its tautomeric form (R²⁷O)P(OH)(OR²⁸) wherein R²⁷ and R²⁶ are each independently selected from a C1-C10 alkyl, and a C6-C30 aryl.

In one embodiment, the emission control agent comprises an organo diphosphate of the formula (V-iii) wherein R²⁹, R³⁰ R³², and R³³ are selected from a monovalent C1-C30 alkyl or a C2-C30 ether group, a C2-C30 alkene comprising one or more points of unsaturation, a C6-C30 aryl, a C7-C30 arylalkyl, and a C7-C30 alkylaryl; and R³¹ is selected from a C1-C30 alkylene, a divalent C2-C30 ether containing group, a C4-C30 cycloalkylene, a C6-C30 arylene, a C7-C30 arylalkylene, and a C7-C30 alkylarylene.

In one embodiment, the emission control agent is selected from alkylphenol di-isodecyl phosphite, dimethyl phosphite, triethyl phosphite, diphenyl phosphite, triphenyl phosphite, isodecyl diphenyl phosphite. 2-ethylhexyl diphenyl phosphite, disodecyl phenyl phosphite, tris(nonylphenyl)phosphite, tetraphenyl dipropyleneglycol diphosphate, poly(dipropyleneglycol) phenyl phosphite, triisooctyl phosphite, trilauryl phosphite, triisodecyl phosphite, tristridecyl phosphite, triisotridecyl phosphite, phosphonic acid di-9-octadecen-1-yl ester. 4.4″-butylidenebis(6-tert-butyl-3-methylphenyl ditridecyl phosphite), tris(dipropylene glycol)phosphite and diisodecyl phenyl phoshpite, or a combination of two or more thereof.

In one embodiment, the emission control agent comprises a thiocarbamate. In one embodiment, the thiocarbamate is selected from tetramethylthiuram disulfide, tetraethylthiuram disulfide, tetrapropylthiuram disulfide, tetrabutylthiuram disulfide, tetradecylthiruam disulfide, tetrahexadecylthiuram disulfide, tetracicosylthiuram disulfide. 1-methyl-1-propyl-6-butyl-6-methyl thiuram disulfide. 1-propyl-1-butyl-6-methyl-6-t-butyl thiuram disulfide, dihexamethylene thiuram disulfide, dipentamethylene thiuram disulfide, tetrabenzylthiuram disulfide, piperidinium pentamethylene dithiocarbamate, piperidinium dibutyl dithiocarbamate, piperidinium dicyclohexyl dithiocarbamate, piperidinium di(3-oxycyclohexyl) dithiocarbamate, ammonium dipropyldithiocarbamate, metal thiocarbamates as for example, nickel dipropyldithiocarbamate, nickel dibutyldithiocarbamate, nickel didecyldithiocarbamate, zinc dimethyldithiocarbamate, zinc diethyldithiocarbamate, zinc dibutyldithiocarbamate, zinc dihexyldithiocarbamate, zinc dibenzyldithiocarbamate, sodium dimethyldithiocarbamate, sodium diethyldithiocarbamate, sodium dibutyldithiocarbamate, sodium di benzyldithiocarbamate, copper dimethyl dithiocarbamate, copper dibutyldithiocarbamate, copper diethyldithiocarbamate, copper diamyldithiocarbamate, copper dioctadecyldithiocarbamate, copper diphenyldithiocarbamate, copper dibenzyldithiocarbamate, copper di(orthotolylaminoethyl) dithiocarbamate, copper dicyclohexyldithiocarbamate, potassium dihexyldithiocarbamate, calcium dihexyldithiocarbamate, zirconium diethyldithiocarbamate, tellurium diethyldithiocarbamate, cobalt dibutyldithiocarbamate, antimony dibutyldithiocarbamate, bismuth dimethyldithiocarbamate, lead dimethyldithiocarbamate, tin dibutyldithiocarbamate, copper dicyclopentyldithiocarbamate, copper 1-butyl-1-cyclohexyl-7-butyl-7-cyclohexyl dithiocarbamate, copper di(3-oxacyclohexyl) dithiocarbamate, copper di(4-oxacyclohexyl) dithiocarbamate, copper di(3-thiocyclohexyl) dithiocarbamate, copper di(4-azacyclohexyl) dithiocarbamate, copper 1-butyl-1-(3-oxacyclohexyl)-7-butyl-7-(3-oxacyclohexyl) dithiocarbamate, copper di(4-pyridyl) dithiocarbamate, copper di(4-N,N-dimethyl anilino) dithiocarbamate, copper di(4-anisyl) dithiocarbamate, copper di(4-thioanisyl) dithiocarbamate, and copper di(3-furanyl) dithiocarbamate.

In one embodiment, the emission control agent is a nitrogen compound selected from a compound of Formula (III), Formula (IV), a nitrogen containing compound selected from one or more of an —OH, —NH, or —NH₂ functionalized pyrrolidine, an —OH, —NH, or —NH₂ functionalized pyrazolidine, an —OH, —NH, or —NH₂ functionalized imidazolidine, an —OH, —NH, or —NH₂ functionalized imidazolidinone, and/or an —OH, —NH, or —NH₂ tetrahydropyrimidinone, or a combination of two or more thereof:

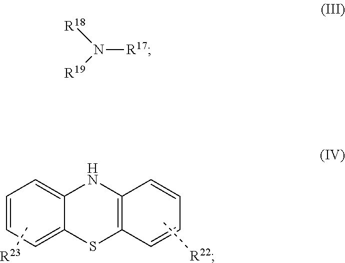

and where R¹⁷, R¹⁸, and R¹⁹ are each independently selected from H, a C1-C20 alkyl group optionally substituted with one or more hydroxyl groups, —R²⁰—OH, or —R²¹—C(O) OH, where R²⁰ and R²¹ are each independently selected from divalent C1-C20 hydrocarbon groups, C4-C30 cyclic hydrocarbon groups, and divalent C6-C30 aryl groups, which may each optionally be substituted with hetoratom containing groups; or two of R¹⁷, R¹⁸, and R¹⁹ may be taken to form a 5-12 membered ring, which ring may optionally include one or more heteroatoms such as N, O in the ring, and which ring may be substituted with a hydroxy functional group, with the proviso that the compound includes at least one —OH or at least one —C(O) OH functional group; and where R²² is hydrogen or a linear or branched C1 to C24 alkyl, aryl, heteroalkyl or alkylaryl group and R²³ is hydrogen or a linear or branched C1 to C24 alkyl, heteroalkyl, or alkylaryl group.

In one embodiment, the emission control agent is selected from a compound of the formula (III), and R¹⁷ is —R²¹—C(O) OH, where R²⁰ and R²¹ are independently selected from divalent C1-C20 hydrocarbon groups, C4-C30 cyclic hydrocarbon groups, and divalent C6-C30 aryl groups, which may each optionally be substituted with hetoratom containing groups.

In one embodiment, the emission control agent is selected from one or more of nicotinic acid, arginine, asparagine, cysteine, glutamine, histidine, methionine, serine, threonine, lysine, 3-aminopyrazine-2-carboxylic acid, tryptophan, and tyrosine.

In one embodiment, the —OH, —NH, or NH₂ functionalized pyrrolidine, pyrazolidine, imidazolidine, or imidazolidinone includes an alcohol, a primary amine, a secondary amine, or carboxylic acid functional group bonded to one of the nitrogen atoms directly or through a linker group.

In one embodiment, the emission control agent is an —OH functional imidazolidinone or pyrimidinone selected from an N-Substituted-(hydroxyalkyl) imidazolidinone, of formula (VI), or an N-substituted-(hydroxyalkyl functionalized) tetrahydro-2-pyrimidinones of formula (VII):

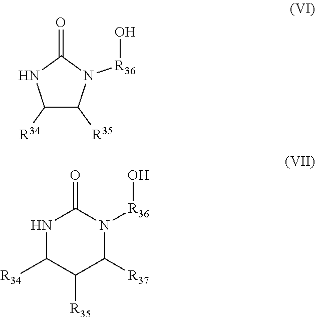

where R³⁴, R³⁵, and R³⁷ are each independently selected from hydrogen or a linear or branched C1-C24 alkyl, a C4-C30 cycloalkyl, a C6-C30 aryl, a C1-C24 heteroalkyl, a C7-C30 alkaryl, or a C7-C30 arylalkyl group; and R³⁶ is selected from a C1-C24 alkylene, a C4-C30 cycloalkylene, a C6-C30 arylene, a C1-C24 heteroalkylene, a C7-C30 alkarylene, or a C7-C30 arylalkylene group.

In one embodiment, the emission control agent is selected from one or more of 1-(hydroxymethyl) imidazolidinone, 1-(2-hydroxyethyl) imidazolidinone, 1-(2-hydroxypropyl) imidazolidinone, and 1-(2-hydroxyethyl)-2-imidazolidinone, tetrahydro-1-(2-hydroxyethyl)-2 (1H)-pyrimidinone.

In one embodiment, the emission control agent is selected from an alkaline earth metal salt of an alkylphenolthioester, a sulfurized alkyl phenol, a metal salt of a sulfurized alkylphenol, a metal salt of a nonsulfurized alkylphenol, an oil soluble phenate, and a sulfurized phenate.

In one embodiment, the emission control agent comprises an alkylated phenothiazine selected from monotetradecylphenothiazine, ditetradecylphenothiazine, monodecylphenothiazine, didecylphenothiazine, monononylphenothiazine, dinonylphenothiazine, monoctylphenothiazine, dioctylphenothiazine, monobutylphenothiazine, dibutylphenothiazine, monostyrylphenothiazine, distyrylphenothiazine, butyloctylphenothiazine, and styryloctylphenothiazine.

In one embodiment in accordance with any previous embodiment, the emission control agent is present in an amount of from about 0.05 part per hundred parts polyol to about 10 parts per hundred parts polyol.

In one embodiment in accordance with any previous embodiment, the emission control agent is provided as an individual component.

In one embodiment in accordance with any previous embodiment, the emission control agent is provided as a mixture with the catalyst, water, plasticizer, natural oils, glycols, chain extenders, alkoxylated monoalcohols.

In one embodiment in accordance with any previous embodiment, the at least one foam reactant is selected from a (i) an isocyanate and (ii) a polyether polyol, a polyester polyol, a polyamine, a polyether amine.

In one embodiment in accordance with any previous embodiment, the emission control agent is provided as a mixture with the isocyanate and/or as a mixture with the polyether polyol, polyamine, and/or polyester polyol.

In another aspect, provided is a method of preparing a polyurethane foam from the composition of any of claims 1-32 comprising contacting the at least one foam reactant with the emission control agent.

In still another aspect, provided is polyurethane foam formed from the method. In one embodiment, the foam has a concentration of at least one aldehyde species that is at least 10% to 99.5% lower than that of a foam formed from the same composition without the emission control agent.

In one embodiment, at least one aldehyde species is present in a concentration less than that of the same composition in the absence of the emission control agent.

In yet another aspect, provided is a method for reducing emission from a polyurethane foam, the method comprising contacting at least one foam reactant with at least one emission control agent in accordance with any previous embodiment,

The following description discloses various illustrative aspects. Some improvements and novel aspects may be expressly identified, while others may be apparent from the description.

### DETAILED DESCRIPTION

Reference will now be made to exemplary embodiments. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the term “foam reactant” means a compound that participates as a reactant for generating polyurethane foam. Examples of such foam reactant include an organic isocyanate and isocyanate reactive compounds selected from the group consisting of polyether polyols, polyester polyols, primary and secondary polyamines, or mixtures or hybrids thereof.

As used herein, the term “emission control agent” means a compound that is capable of controlling the emission of volatiles responsible for odor. In one embodiment, the term “emission control agent” refers to a compound that is capable of reducing the content of an aldehyde species in a composition and/or hindering the formation of an aldehyde species during a foam forming process or in a finished foam product.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B: A employs C: or A employs both B and C). As another matter, the articles “a” and “an” are generally intended to mean “one or more” unless context suggest otherwise.

The term “alkyl” includes straight, branched, and cyclic monovalent hydrocarbon groups, which may be substituted with a heteroatom or heteroatom containing group. In embodiments, the term alkyl may include C1-C30 alkyl groups. Examples of suitable alkyl groups include, but are not limited to, methyl, ethyl, n-propyl, isopropyl, n-butyl, isobutyl, sec-butyl, tert-butyl, n-pentyl, isopentyl, neopentyl, tert-pentyl, hexyl such as n-hexyl, heptyl such as n-heptyl, octyl such as n-octyl, isooctyl and 2-ethyl hexyl, nonyl such as n-nonyl, and decyl such as n-decyl, etc.

The term “alkoxy” as used herein means a monovalent group of —O-alkyl with the alkyl being defined as above.

The term “alkylene” includes straight, branched, and cyclic divalent hydrocarbon groups, which may be substituted with a heteroatom or heteroatom containing group. In embodiments, the term alkylene includes C1-C30 alkylene groups. Examples of alkylenes include, but are not limited to, methylene, ethylene, propylene, isopropylene, butylene, isobutylene, tertbutylene, pentylene, hexylene, heptylene, octylene, nonylene, decylene, etc.

The term “aryl” includes any monovalent aromatic hydrocarbon or a heteroaromatic group, which may be substituted with a heteroatom or heteroatom containing group. This term also includes fused systems containing an aromatic group and groups with multiple aryl groups joined by a bond or linker group. In embodiments, the term aryl include C5-C30 aryl groups, fused aryl groups comprising two or more C5-C20 aryl groups, and multi-aryl group structures comprising two or more C5-C20 aryl groups joined by a linker group. Illustrative examples of aryls include phenyl, naphthalenyl, benzyl, phenethyl, o-, m- and p-tolyl, and xylyl.

The term “arylene” includes any divalent aromatic hydrocarbon group, which may be substituted with a heteroatom or heteroatom containing group this term also includes fused systems containing an aromatic group. In embodiments, the term aryl includes C5-C20 arylene groups, fused arylene groups comprising two or more C5-C20 aryl groups, and multi-arylene group structures comprising two or more C5-C20 aryl groups joined by a linker group.

The term “aralkyl” include straight, branched, and cyclic monovalent hydrocarbon groups substituted with an aryl substituent. The term “aralkylene” refers to a divalent aralkyl group.

The term “alkaryl” include aryl groups substituted with one or more alkyl substituents. The term “alkarylene” refers to a divalent alkaryl group.

The term “cyclic” as used herein refers to compounds which include any molecules having at least three atoms joined together to form a ring (excluding a phenyl ring). The term “cyclo” or “cyclic” includes a monovalent cyclic hydrocarbon and includes, free cyclic groups, bicyclic groups, tricyclic groups, and higher cyclic structures, as well as bridged cyclic groups, fused cyclic groups, and fused cyclic groups containing at least one bridged cyclic group. The ring may be, for example, a three-membered to ten-membered ring, specifically a four-membered to eight-membered ring, more specifically, four-, five-, six-, seven-, or eight-membered ring. In embodiments, a cyclic alkyl includes a C3-C20 cyclic alkyl group. Example of suitable cyclic groups include, but are not limited to, cyclopropyl, cyclopentyl, cyclohexyl, norbornyl, bicyclo[2.2.2]nonane, adamantyl, or tetrahydronaphthyl (tetralin).

The term “cyclo” or “cyclic” alkylene includes a divalent cyclic hydrocarbon and includes, free cyclic groups, bicyclic groups, tricyclic groups, and higher cyclic structures, as well as bridged cyclic groups, fused cyclic groups, and fused cyclic groups containing at least one bridged cyclic group. In embodiments, a cyclic alkylene includes a C3-C20 cyclic alkylene group.

The term “alkynyl” is defined as a C2-10 branched or straight-chain unsaturated aliphatic hydrocarbon groups having one or more triple bonds between two or more carbon atoms. Examples of alkynes include ethynyl, propynyl, butynyl, pentynyl, hexynyl, heptynyl, octynyl and nonynyl.

The term “substituted” means that one or more hydrogens on the molecule, portion of the molecule, or atom are replaced by a substitution group provided that the normal valency is not exceeded. The substitution group can be a heteroatom. The term “hetero” as used refer to an atom or in conjunction with another group includes an atom or group containing an atom such as oxygen, nitrogen, sulfur, silicon, phosphorus, boron, etc. Examples of suitable substitution groups include, but are not limited to, —OR, —NR′R, —C(O)R, —SR, -halo, —CN, —NO₂, —SO₂, phosphoryl, imino, thioester, carbocyclic, aryl, heteroaryl, alkyl, alkenyl, bicyclic and tricyclic groups. When a substitution group is a keto (i.e., —0) group, then 2 hydrogens on the atom are replaced. Keto substituents are not present on aromatic moieties. The terms R and R′ refer to alkyl groups that may be the same or different.

Provided is a composition and method for reducing emission from polyurethane foams. In accordance with the present technology, provided is a composition comprising at least one foam reactant, an emission control agent, and a catalyst. In one embodiment, the emission control agent is selected from (i) a phosphorous containing compound: (ii) a thiocarbamate: (iii) a nitrogen containing compound: (iv) a phenolic antioxidant: or a combination of two or more thereof. Non-limiting examples of suitable materials include, but are not limited to, an amino alcohol, an amino acid, an alkaline earth metal salt of an alkylphenolthioester: a sulfurized alkyl phenol: a metal salt of a sulfurized alkylphenol: a metal salt of a nonsulfurized alkylphenol: an oil soluble phenate: a sulfurized phenate: a phosphite triester (e.g., a compound with a structure of P(OR)₃); a diorganophosphite (e.g., a compound with a structure of P(OR)₂OH or it's tautomeric form HP(OR)₂O); an organodiphosphite [(OR)₂P-Z-P(OR)₂], a thiocarbamate, an —OH, —NH, or —NH₂ functionalized pyrrolidine, an —OH, —NH, or —NH₂ functionalized pyrazolidine, an —OH, —NH, or —NH₂ functionalized imidazolidine, an —OH, —NH, or —NH₂ functionalized imidazolidinone, and/or an —OH, —NH, or —NH₂ tetrahydropyrimidinone or a combination of two or more thereof.

In one embodiment, the emission control agent is selected from at least one compound from the group consisting of:

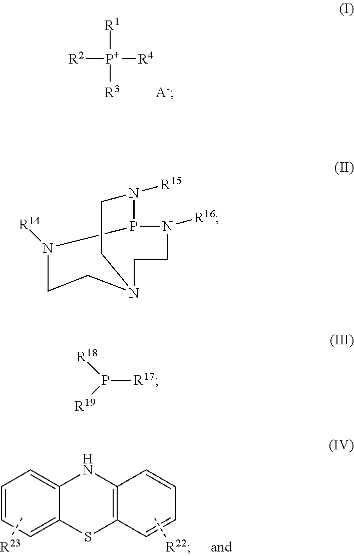

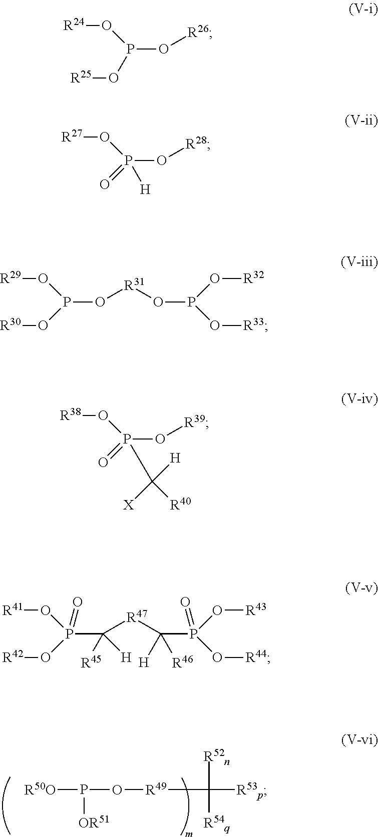

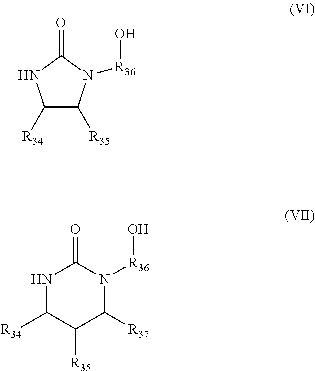

In one embodiment, the emission control agent is a phosphorous based material selected from a phosphnium compound of the formula (I):

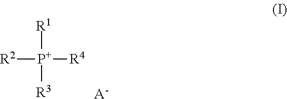

where R¹ is selected from a C6-C30 aryl, or —N(R⁵) R⁶, where R⁵ and R⁶ are each independently selected from hydrogen, monovalent organic groups, monovalent heteroorganic groups (for example, comprising nitrogen, oxygen, phosphorus, silicon, or sulfur in the form of groups or moieties that are preferably bonded through a carbon atom and that do not contain acid functionality such as carboxylic or sulfonic), and combinations thereof, or R⁵ and R⁶ can be taken together to form a 5-10 membered ring: R² is selected from a C6-C30 aryl, —N(R⁵) R⁶, and —OR⁷, where R⁵ and R⁶ are each independently selected from hydrogen, monovalent organic groups, monovalent heteroorganic groups (for example, comprising nitrogen, oxygen, phosphorus, silicon, or sulfur in the form of groups or moieties that are preferably bonded through a carbon atom and that do not contain acid functionality such as carboxylic or sulfonic), and combinations thereof, or R⁵ and R⁶ can be taken together to form a 5-10 membered ring, and R⁷ is selected from a C1-C10 alkyl: R³ is selected from a C6-C30 aryl, —N(R⁵) R⁶, and —OR⁸, where R⁵ and R⁶ are each independently selected from hydrogen, monovalent organic groups, monovalent heteroorganic groups (for example, comprising nitrogen, oxygen, phosphorus, silicon, or sulfur in the form of groups or moieties that are preferably bonded through a carbon atom and that do not contain acid functionality such as carboxylic or sulfonic), and combinations thereof, or R⁵ and R⁶ can be taken together to form a 5-10 membered ring, and R⁸ is selected from a C1-C10 alkyl: R⁴ is selected from —CH₂—R⁹ or ═N—R¹⁰, where R⁹ is selected from —C(O)—OₓR¹¹, —CN, —R¹²CN, or —R¹³—CH₂—PR¹R²R³, where R¹¹ is a C1-C10 alkyl, a C1-C10 alcohol, or a C1-C10 alkoxy: R¹² and R¹³ are each selected from a C1-C10 alkyl or a C6-C30 aryl, x is 0 or 1, and R¹, R², and R³ are as described above; and R¹⁰ is selected from a C1-C10 alkyl or a C6-C30 aryl; and A⁻ is selected from an organic or inorganic anion with a valence to counteract the charge of the phosphorus atom.

In one embodiment, R⁵ and R⁶ are each independently selected from H and a C1-C10 alkyl, or a C6-C30 aryl.

It will be appreciated that the phosphorous atom may have a positive charge depending on the substituents selected for the R¹-R⁴ groups. Where the phosphorous atom has a positive charge, the compound may include an appropriate counter ion (A⁻) to provide an electroneutral compound. The counter ion is not particularly limited and can be selected as desired. In embodiments, the counter ion is selected from an organic or an incorganic anion. Examples of suitable anions include, a halide, such as F⁻, CI⁻, I⁻, or Br⁻, a hydroxide, a carbonate, a sulfate, a carboxylate, an acetate, mesylate, tosylate, alcoholate, perchlorate, and the like.

It will be appreciated that when R⁴ is ═N—R¹⁰, the P atom in Formula (I) will be pentavalent and not have a positive charge such that no counteranion A⁻ is needed.

In one embodiment, R¹—R³ are each a C6-C30 aryl, and R⁴ is —CH₂—R⁹ where R⁹ is —CN. In one embodiment, R¹—R³ are each phenyl.

In one embodiment, the emission control agent is selected from a compound of formula (I), where R¹, R², and R³ are each independently selected from a C6-C30 aryl, and R⁴ is selected from —CH₂—R⁹: ═N—R¹⁰: where R⁹ is selected from —C(O)—OₓR¹¹, —CN, or —R¹²CN: R¹¹ is a C1-C10 alkyl, a C1-C10 alcohol, or a C1-C10 alkoxy: R¹² is selected from a C1-C10 alkyl or a C6-C30 aryl; and x is 0 or 1.

In one embodiment, the emission control agent is selected from a compound of formula (I), where R¹, R², and R³ are each independently selected from —N(R⁵) R⁶ where R⁵ and R⁶ are each independently a C1-C10 alkyl group; and R⁴ is selected from ═N—R¹⁰ where R¹⁰ is selected from a C1-C10 alkyl or a C6-C30 aryl.

In one embodiment, the emission control agent is selected from a compound of formula (I), where R¹ is R² is —OR⁷: R³ is —OR⁸: where R⁷ and R⁸ are each independently a C1-C10 alkyl: R⁴ is —CH₂—R⁹ where R⁹ is selected from —C(O)—OₓR¹¹, where R¹¹ is H, a C1-C10 alkyl, a C1-C10 alcohol, or a C1-C10 alkoxy.

It will be appreciated that where the phosphorous atom in a compound of Formula (I) is in a four-coordinate state, the phosphorous atom will have a positive charge, and the compound will be provided with an appropriate anion to balance the charge. The anion may be any anion as desired for a particular purpose or intended application. Examples of suitable anions include, chloride, bromide, iodide, hexafluorophosphate, acetate, etc.

In another embodiment, the phosphorous based compound is a phosphazene compound of the formula (II):

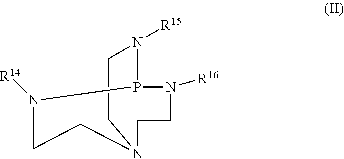

where R¹⁴, R¹⁵, and R¹⁶ are each independently chosen from hydrogen, monovalent organic groups, monovalent heteroorganic groups (for example, comprising nitrogen, oxygen, phosphorus, silicon, or sulfur in the form of groups or moieties that are preferably bonded through a carbon atom and that do not contain acid functionality such as carboxylic or sulfonic), and combinations thereof (less preferably hydrogen). The organic and heteroorganic groups preferably have from 1 to about 20 carbon atoms (more preferably, from 1 to about 10 carbon atoms: most preferably, from 1 to about 6 carbon atoms).

Examples of suitable phosphorous based compounds for the emission control agent include, but are not limited to, (cyanomethyl)-triphenylphosphonium chloride, (methoxycarbonylmethyl)-triphenylphosphonium bromide, tert-butylimino-tris (dimethylamino)phosphorene (phosphazene base P1-t-Bu), tert-butylimino-tri (pyrrolidino)phosphorane [phosphazene base P1-t-Bu-tris(tetramethylene)], tert-octylimino-tris (dimethylamino)phosphorane (phosphazene base P1-t-Oct), 2,8,9-trimethyl-2,5,8,9-tetraaza-1-phosphabicyclo[3.3.3]undecane, 2,8,9-triisopropyl-2,5,8,9-tetraaza-1-phosphabicyclo[3.3.3]undecane, 2,8,9-triisobutyl-2,5,8,9-tetraaza-1-phosphabicyclo[3.3.3]undecane, 3,9-bis(octadecyloxy)-2,4,8,10-tetraoxa-3,9-diphosphaspiro [5.5]undecane, 4,4′-bis(diethylphosphonomethyl) biphenyl, diethyl-4-cyano benzyl phosphonate, N-methoxy-N-methyl(triphenylphosphoranylidene) acetamide, dimethyl(2-oxopropyl)phosphonate, diethyl(2-oxopropyl)phosphonate, dimethyl(2-oxoheptyl)phosphonate, diethyl(2-oxoheptyl)phosphonate, diethyl carboxymethylphosphonate, diethyl(2-oxo-2-phenylethyl)phosphonate, diethyl (methylthiomethyl)phosphonate, methyl(triphenylphosphoranylidene) acetate, diethylphosphonoacetic acid, 9,10-dihydro-9-oxo-10-phosphophenanthrene-10-oxide, and the like.

Amino alcohol compounds may also be referred to as alkanolamines and can be selected from primary, secondary, and/or tertiary cyclic amines comprising hydroxy (i.e., alcohol) functionality. Amino acid compounds are those amino-functional compounds that besides one amino and one carboxyl(—C(O) OH) group include a further functionality like thio-(—SH, like cysteine), —SR (like methionine), amide (—C(O) NH₂, like asparagine), primary amino (like lysine), heterocyclic group (like histidine, tryptophane), phenolic group (like tyrosine). Amino based compounds suitable for use as the emission control agents include, but are not limited to, those of the formula (III):

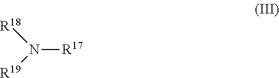

where R¹⁷, R¹⁸, and R¹⁹ are each independently selected from H, a C1-C20 alkyl group optionally substituted with one or more hydroxyl groups, —R²⁰—OH, or —R²¹—C(O) OH, where R²⁰ and R²¹ are each independently selected from divalent C1-C20 hydrocarbon groups, C4-C30 cyclic hydrocarbon groups, and divalent C6-C30 aryl groups, which may each optionally be substituted with hetoratom containing groups (e.g., amino groups); where the compound (III) is not selected from diethynolamine, or triethanoliamine, or two of R¹⁷, R¹⁸, and R¹⁹ may be taken to form a 5-12 membered ring, which ring may optionally include one or more heteroatoms such as N, O in the ring, and which ring may be substituted with a hydroxy functional group, with the proviso that the compound includes at least one-OH or at least one —C(O) OH functional group.

Examples of suitable amino alcohols or amino acids include, but are not limited to, 2-hydroxypyridine, aminocresol, 2,4-quinolinediol, 3-indolemethanol hydrate, 4-(2-hydroxyethyl) morpholine, 2-(2-hydroxyethyl) pyridine, 1-(2-hydroxyethyl) piperazine, 1-[2-(2-hydroxyethoxy) ethyl]piperazine, piperidine methanol, piperidine ethanol, 1-(2-hydroxyethyl) pyrrolidine, 1-(2-hydroxyethyl)-2-pyrrolidone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxyethyl) phthalimide, N-(2-hydroxyethyl) isonicotinamide, 2-(1-piperadinyl) ethanol, 2-(4-amino-1-piperadinyl) ethanol, 2-piperidinemethanol, etc.

Examples of suitable amino acid compounds include, but are not limited to, nicotinic acid, arginine, asparagine, cysteine, glutamine, histidine, methionine, serine, threonine, lysine, 3-aminopyrazine-2-carboxylic acid, tryptophan, tyrosine, and the like.

Still other compounds suitable for use as an emission control agent can be selected from a variety of materials including, but not limited to, sulfurized hindered phenols, alkaline earth metal salts of alkylphenolthioesters having C₅ to C12 alkyl side chains, sulfurized alkylphenols, metal salts of either sulfurized or nonsulfurized alkylphenols, for example calcium nonylphenol sulfide, oil soluble phenates and sulfurized phenates, phosphosulfurized or sulfurized hydrocarbons, phosphorus esters, and thiocarbamates.

In one embodiment, the emission control agent is selected from a phenothiazine or alkylated phenothiazine having the chemical formula (IV):

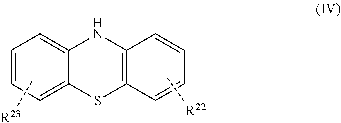

wherein R²² is hydrogen or a linear or branched C1 to C24 alkyl, aryl, heteroalkyl or alkylaryl group and R²³ is hydrogen or a linear or branched C1 to C24 alkyl, heteroalkyl, or alkylaryl group. Alkylated phenothiazine may be selected from the group consisting of monotetradecylphenothiazine, ditetradecylphenothiazine, monodecylphenothiazine, didecylphenothiazine, monononylphenothiazine, dinonylphenothiazine, monoctylphenothiazine, dioctylphenothiazine, monobutylphenothiazine, dibutylphenothiazine, monostyrylphenothiazine, distyrylphenothiazine, butyloctylphenothiazine, and styryloctylphenothiazine.

In one embodiment, the emission control agent is a material selected from a thiocarbamate. Examples of suitable thiocarbamates include, but are not limited to, include, tetramethylthiuram disulfide, tetraethylthiuram disulfide, tetrapropylthiuram disulfide, tetrabutylthiuram disulfide, tetradecylthiruam disulfide, tetrahexadecylthiuram disulfide, tetracicosylthiuram disulfide, 1-methyl-1-propyl-6-butyl-6-methyl thiuram disulfide, 1-propyl-1-butyl-6-methyl-6-t-butyl thiuram disulfide, dihexamethylene thiuram disulfide, dipentamethylene thiuram disulfide, tetrabenzylthiuram disulfide, piperidinium pentamethylene dithiocarbamate, piperidinium dibutyl dithiocarbamate, piperidinium dicyclohexyl dithiocarbamate, piperidinium di(3-oxycyclohexyl) dithiocarbamate, ammonium dipropyldithiocarbamate, metal thiocarbamates as for example, nickel dipropyldithiocarbamate, nickel dibutyldithiocarbamate, nickel didecyldithiocarbamate, zinc dimethyldithiocarbamate, zinc diethyldithiocarbamate, zinc dibutyldithiocarbamate, zinc dihexyldithiocarbamate, zinc dibenzyldithiocarbamate, sodium dimethyldithiocarbamate, sodium diethyldithiocarbamate, sodium dibuty ldithiocarbamate, sodium dibenzyldithiocarbamate, copper dimethyl dithiocarbamate, copper dibutyldithiocarbamate, copper diethyldithiocarbamate, copper diamyldithiocarbamate, copper dioctadecyldithiocarbamate, copper diphenyldithiocarbamate, copper dibenzyldithiocarbamate, copper di(orthotolylaminoethyl) dithiocarbamate, copper dicyclohexyldithiocarbamate, potassium dihexyldithiocarbamate, calcium dihexyldithiocarbamate, zirconium diethyldithiocarbamate, tellurium diethyldithiocarbamate, cobalt dibutyldithiocarbamate, antimony dibutyldithiocarbamate, bismuth dimethyldithiocarbamate, lead dimethyldithiocarbamate, tin dibutyldithiocarbamate, copper dicyclopentyldithiocarbamate, copper 1-butyl-1-cyclohexyl-7-butyl-7-cyclohexyl dithiocarbamate, copper di(3-oxacyclohexyl) dithiocarbamate, copper di(4-oxacyclohexyl) dithiocarbamate, copper di(3-thiocyclohexyl) dithiocarbamate, copper di(4-azacyclohexyl) dithiocarbamate, copper 1-butyl-1-(3-oxacyclohexyl)-7-butyl-7-(3-oxacyclohexyl) dithiocarbamate, copper di(4-pyridyl) dithiocarbamate, copper di(4-N,N-dimethyl anilino) dithiocarbamate, copper di(4-anisyl) dithiocarbamate, copper di(4-thioanisyl) dithiocarbamate, and copper di(3-furanyl) dithiocarbamate.

The emission control agent can also be selected from a phosphite or a phosphonate. In one embodiment, the phosphite is selected from a phosphite triester, a diorganophsophite, an organodiphosphite, or a phosphite substituted polymer. It will be appreciated that diorganophosphites may be tautomeric compounds that can have a general formula HP(OR)₂O and the tautomeric form P(OR)₂OH. In one embodiment, the phosphonate can be selected from a phosphonate having a CH or CH₂ moiety attached to a phosphorous atom.

In one embodiment, the emission control agent is selected from a compound of the formula (V-i), (V-ii), (V-iii), (V-iv), (V-v), and/or (V-vi):

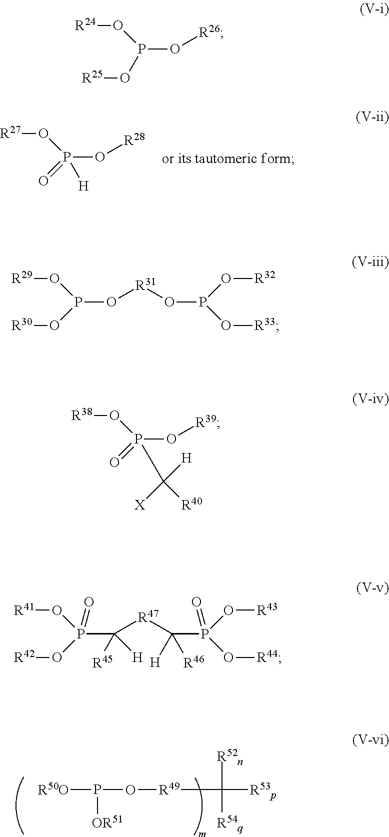

where R²⁴, R²⁵, R²⁶ R²⁷, R²⁸ R²⁹, R³⁰, R³², R³³ R³⁸ R³⁹, R⁴¹, R⁴² R⁴³, R⁴⁴, R⁵⁰, and R$1 are each independently selected from a monovalent C1-C30 alkyl, a C2-C30 alkene comprising one or more points of unsaturation, a C4-C30 cycloalkyl, a C2-C30 ether group a C2-C30 alkylene glycol, a C2-C30 polyalkylene glycol, a C6-C30 aryl, a C7-C30 arylalkyl, and a C7-C30 alkylaryl:
R³¹, R⁴⁷, and R⁴⁹ are each independently selected from a C1-C30 alkylene, a C4-C30 cycloalkylene, a C6-C30 arylene, a C7-C30 arylalkylene, and a C7-C30 alkylarylene:
R⁴⁰, R⁴⁵, R⁴⁶, R⁵², R⁵³, and R⁵⁴ are each independently selected from hydrogen, a monovalent C1-C30 alkyl, a C2-C30 alkene comprising one or more points of unsaturation, a C4-C30) cycloalkyl, a C2-C30 ether group, a C6-C30 aryl, a C7-C30 arylalkyl, and a C7-C30 alkylaryl: X is C(O)—R⁴⁸, a C1-C30 alkyl, a C6-C30 aryl optionally substituted with a cyano, OH, where R⁴⁸ is selected from a C1-C30 alkyl. In the compounds. (V-i), (V-ii), (V-iii), (V-iv), and (V-v), the respective R groups can be the same or different from one another. In one embodiment, the R groups in the phosphite are each the same. In one embodiment, two R groups in the phosphite are the same. In another embodiment, each of the R groups in the phosphite are different. It will be appreciated that the alkyl and alkene groups can be linear or branched. They may also optionally contain one or more heteroatoms in the chain and may include a functional group such as, for example, an OH, amine, —SH, etc. Additionally, the carbon atoms for the cycloalkyl and aryl groups can refer to the number of atoms in the ring structure, or it can refer to the total number carbons in the compound, i.e., it can include the size of the ring and the groups attached to the ring. The cycloalkyl and aryl groups can also include functional groups such as OH, amine, —SH, and the like:
m is 1-4, 2-3, and in one embodiment 2: n is 0-3, p is 0-3, and q is 0-3: where m+n+p+q is 4; and n+p+q is 0-3.

Examples of suitable groups for R²⁴, R²⁵, R²⁶ R²⁷, R²⁸ R²⁹, R³⁰, R³², R³³ R³⁸ R³⁹, R⁴¹, R⁴², R⁴³, and R⁴⁴ include, but are not limited to, methyl, ethyl, propyl, isopropyl, butyl, isobutyl, tertbutyl, pentyl, isopentyl, hexyl, isohexyl, heptyl, isoheptyl, ocytl, isooctyl, nonyl, decyl, isodecyl, dodecyl, isododecyl, tridecyl, isotridecyl, lauryl, 2-ethylhexyl, phenyl, tosyl, methylphenyl. 6-tertbutyl-3-methylphenyl, ethylene glycol, propylene glycol, diethylene glycol, dipropylene glycol, triethylene glycol, tripropylene glycol, etc.

Some examples of suitable phosphites include, but are not limited to, alkylphenol di-isodecyl phosphite, dimethyl phosphite, triethyl phosphite, diphenyl phosphite, triphenyl phosphite, isodecyl diphenyl phosphite, 2-ethylhexyl diphenyl phosphite, disodecyl phenyl phosphite, tris(nonylphenyl)phosphite, tetraphenyl dipropyleneglycol diphosphate, poly(dipropyleneglycol) phenyl phosphite, triisooctyl phosphite, trilauryl phosphite, triisodecyl phosphite, tristridecyl phosphite, triisotridecyl phosphite, phosphonic acid di-9-octadecen-1-yl ester, 4,4′-butylidenebis(6-tert-butyl-3-methylphenyl ditridecyl phosphite, tris(dipropylene glycol)phosphite and diisodecyl phenyl phoshpite.

Examples of suitable phosphonates include, but are not limited to, dimethyl(2-oxypropyl)phosphonate, dimethyl(2-oxoethyl)phosphonate, diethyl(2-oxophropyl)phosphonate, diethyl(4-cyanoenzyl)phosponate, and 4,4′-bis(diethylphosphomethyl) biphenyl.

In one embodiment, the phosphite can be a provided as a polymer substituted with phosphite groups. For example, the polymer can be a polyolefin polymer wherein one or more of the hydrogen atoms on a carbon is replaced by a phosphite group. The polymer can be a random or block copolymer with phosphite substituent groups. Examples include but are not limited to polyethylene, polypropylene, polybutylene, and the like. A non-limiting example of a polymer substituted with a phosphite would be a polymer with a repeating unit:

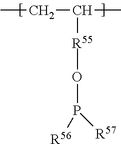

where R⁵⁵ is a bond, a C1-C30 alkylene, a C4-C30 cycloalkylene, a C6-C30 arylene, a C7-C30 arylalkylene, and a C7-C30 alkylarylene; and R⁵⁶ and R⁵⁷ are independently selected from a monovalent C1-C30 alkyl, a C2-C30 alkene comprising one or more points of unsaturation, a C4-C30 cycloalkyl, a C2-C30 ether group, a C6-C30 aryl, a C7-C30 arylalkyl, and a C7-C30 alkylaryl.

The emission control compound can also be selected from a pyrrolidine, pyrazolidine, imidazolidine, imidazolidinone, pyrimidinone, and the like, where the compound includes an alcohol, carboxylic acid functional group, —NH group, or —NH₂ group preferably bonded to one of the nitrogen atoms either directly or through a linker group. Non-limiting examples of such compounds include, for example, 1-(hydroxymethyl) imidazolidinone, 1-(2-hydroxyethyl) imidazolidinone, 1-(2-hydroxypropyl) imidazolidinone, 1-(2-hydroxyethyl)-2-imidazolidinone, etc.

In one embodiment, the emission control agent is selected from an —OH, —NH, or —NH₂ functionalized pyrrolidine, an —OH, —NH, or —NH₂ functionalized pyrazolidine, an —OH, —NH, or —NH₂ functionalized imidazolidine, an —OH, —NH, or —NH₂ functionalized imidazolidinone, and/or an —OH, —NH, or —NH₂ tetrahydropyrimidinone.

In one embodiment, the emission control agent is an —OH functional imidazolidinone or selected pyrimidinone from an N-Substituted-(hydroxyalkyl) imidazolidinone, of formula (VI), or an N-substituted-(hydrocyalkyl functionalized) tetrahydro-2-pyrimidinones of formula (VII):

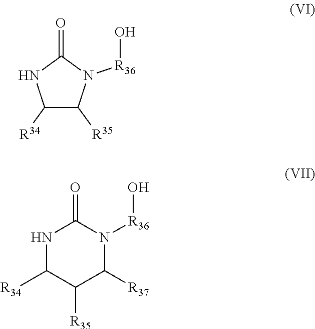

where R³⁴, R³⁵, and R³⁷ are each independently selected from hydrogen or a linear or branched C1-C24 alkyl, a C4-C30 cycloalkyl, a C6-C30 aryl, a C1-C24 heteroalkyl, a C7-C30 alkaryl, or a C7-C30 arylalkyl group; and R³⁶ is selected from a C1-C24 alkylene, a C4-C30 cycloalkylene, a C6-C30 arylene, a C1-C24 heteroalkylene, a C7-C30 alkarylene, or a C7-C30 arylalkylene group.

Typically, the emission control agent is a component of the composition used for foaming. The emission control agent is either in the polyol part of the composition used for foaming or it is in the isocyanate part of the composition used for foaming or it's present in the mixture of polyol or isocyanate or added along with the catalyst. Alternatively, the emission control agent is added separately into the composition for foaming, during the foaming process. Typically, the emission control agent is employed in an amount of from about 0.05 to about 10 part per hundred parts polyol (pphp), from about 0.1 to about 7.5 pphp, from about 0.5 to about 5 pphp, or from about 1 to about 3 pphp.

The compositions for preparing polyurethane foam are not particularly limited and can be selected as desired for a particular purpose or intended application. Various kinds of compositions that can be utilized include, but are not limited to, high resilience foams, flexible foams, viscoelastic foams, microcellular foams, rigid foam etc. High resilience polyurethane foams are produced by reacting an isocyanate with an isocyanate-reactive compound containing two or more reactive sites, generally in the presence of blowing agent(s), catalysts, surfactants and other auxiliary additives. The isocyanate-reactive compounds are typically polyether polyols, polyester polyols, primary and secondary polyamines, or water. The catalysts used during the preparation of polyurethane foam promote two major reactions among the reactants, gelling and blowing. These reactions must proceed simultaneously and at a competitively balanced rate during the process in order to yield polyurethane foam with desired physical characteristics. Flexible molded polyurethane molded foams need to have certain degree of open cells, which may require additional processing, such as crushing the foams, to reach a desired cell-openness.

Examples of suitable polyols for preparing a polyurethane foam are those having an average number of hydroxyl groups per molecule of at least 2 and, typically from about 2 to about 3.5 hydroxyl groups per molecule. Included among the useful polyols are polyether diols and triols, polyester diols and triols and hydroxyl-terminated polyolefin polyols such as the polybutadiene diols. Other useful polyols include copolymers of polymeric materials grafted onto the main polyol chain such as, for example, SAN (styrene/acrylonitrile) or AN (acrylonitrile) grafted onto polyether polyols, commonly referred to as copolymer polyols, polyols derived from naturally occurring materials such as castor oil, chemically-modified soybean oil or other chemically-modified fatty acid oils and polyols resulting from the alkoxylation of such naturally occurring materials as castor oil and soybean oil.

Exemplary polyols are the polyether diols and triols, particularly those derived from one or more alkylene oxides, phenyl-substituted alkylene oxides, phenyl-substituted alkylene oxides and/or ring-opening cyclic ethers such as ethylene oxide, propylene oxide, styrene oxide, tetrahydrofuran, and the like, advantageously having a number average molecular weight of from 1000 to 6000 and preferably a weight average molecular weight from 2500 to 4000.

Examples of polyisocyanates used for preparing polyurethane foams include, but are not limited to, toluene diisocyanate (TDI), including 2,4 and 2,6 isomers and isocyanate prepolymers of TDI made from the reaction of TDI with polyols, or other aromatic or aliphatic isocyanates, and the index of the foam is typically 60 to 130. According to one embodiment of the present invention, the polyisocyanate can be a hydrocarbon diisocyanate, (e.g. alkylenediisocyanate and arylene diisocyanate), such as toluene diisocyanate, diphenylmethane isocyanate, including polymeric versions, and combinations thereof. In yet another embodiment of the invention, the polyisocyanate can be isomers of the above, such as methylene diphenyl diisocyanate (MDI) and 2,4- and 2,6-toluene diisocyanate (TDI), as well as known triisocyanates and polymethylene poly (phenylene isocyanates) also known as polymeric or crude MDI and combinations thereof. Non-limiting examples of isomers of 2,4- and 2,6-toluene diisocyanate include Mondur™ TD80 or Papi™ 27 and combinations thereof. Mondur™ is a registered trademark of Covestro. Papi™ is a registered trademark of Dow Chemical Company.

The composition of the invention can additionally contain a surfactant. The surfactants usually employed in the composition are not particularly limited and can be selected as desired for a particular purpose or intended application. Examples of surfactants include, but are not limited to, surfactants include polyethylene glycol, polypropylene glycol, ethoxylated castor oil, oleic acid ethoxylate, alkylphenol ethoxylates, copolymers of ethylene oxide (EO) and propylene oxide (PO) and copolymers of silicones and polyethers (silicone polyether copolymers), copolymers of silicones, dimethyl silicone oils, and copolymers of ethylene oxide and propylene oxide and mixtures thereof. Examples of suitable surfactants include those under the tradename NIAX™ available from Momentive Performance Materials Inc.

Catalysts used in the composition of the present invention are not particularly limited and can be selected as desired for a particular purpose or intended application. Examples of suitable catalysts include short chain tertiary amines or tertiary amines containing at least an oxygen such as, but not limited to, 1-[bis[3-(dimethylamino) propyl]amino]-2-propanol. 2-[2-(dimethylamino)ethoxy]ethanol, 2-[2-(dimethylamino)ethyl-methyl-amino]ethanol. 3,3′-iminobis(N,N-dimethylpropylamine), dimethylaminoethanol. 3-(dimethylamino)-1-propylamine. 3-(diethylamino)-1-propylamine. 2-[2-[2-(dimethylamino) ethoxy]ethyl-methylamino]ethanol. 3-{[3-(dimethylamino) propyl]-methylamino}propanol. 2-{[3-(dimethylamino) propyl]-methyl-amino}ethanol. 2-[2-(dimethylamino) ethoxy]ethanol, 1-[bis[3-(dimethylamino)propyl]amino]-2-propanol. 2-{[2-(dimethylamino) ethyl]-methylamino}ethanol, bis —(2-dimethylaminoethyl) ether: pentamethyldiethylene-triamine, triethylamine, tributyl amine, N,N-dimethylaminopropylamine, dimethylethanolamine. N,N,N′,N′-tetra-methylethylenediamine, or urea. Still other examples of suitable catalysts include, but are not limited to, amidines, organometallic compounds, and combinations thereof. These may include, but are not limited to, amidines such as 1,8-diazabicyclo [5.4.0]undec-7-ene and 2,3-dimethyl-3,4,5,6-tetrahydropyrimidine, and their salts.

Organometallic compounds may include organotin compounds, such as, but not limited to, tin (II) salts of organic carboxylic acids, e.g., tin (II) diacetate, tin (II) dioctanoate, tin (II) diethylhexanoate, and tin (II) dilaurate, and dialkyltin (IV) salts of organic carboxylic acids, e.g., dibutyltin diacetate, dibutyltin dilaurate, dibutyltin maleate and dioctyltin diacetate. Bismuth salts of organic carboxylic acids may also be selected, such as, for example, bismuth octanoate. The organometallic compounds may be selected for use alone or in combinations, or, in some embodiments, in combination with one or more of the highly basic amines listed hereinabove.

Example of catalysts able to promote both blowing and curing reactions are cyclic tertiary amines or long chain amines containing several nitrogen atomes such as, dimethylbenzylamine, N-methyl-, N-ethyl-, and N-cyclohexylmorpholine, N,N,N′,N′-tetramethylbutanediamine and -hexanediamine, bis(dimethylamino-propyl) urea, dimethylpiperazine, dimethylcyclohexylamine, 1,2-dimethyl-imidazole, 1-aza-bicyclo[3.3.0]octane, triethylenediamine (TEDA). In one embodiment, 1,4-diazabicyclo[2.2.2]octane (TEDA) is used.

Another class of catalysts for both blowing and curing reactions are alkanolamine compounds, such as triethanolamine, triisopropanolamine, N-methyl- and N-ethyldiethanolamine, and dimethylethanolamine may also be selected. Combinations of any of the above may also be effectively employed. Some of these catalysts are also acting as crosslinkers when they contain more than one reactive hydrogen. This is the case, for instance, of triethanolamine.

Examples of suitable catalysts include those sold under the tradename NIAX™ available from Momentive Performance Materials Inc.

The composition of the present invention could additionally contain many attribute enhancing agents. Examples of such attribute enhancing agents used in the composition for preparing polyurethane foam include, but are not limited to blowing agents, organic flame retardants: antiozonants, antioxidants: thermal or thermal-oxidative degradation inhibitors, UV stabilizers, UV absorbers or any such agent that when added to the foam-forming composition will prevent or inhibit thermal, light, and/or chemical degradation of the resulting foam. Also contemplated for use herein in the composition of the present invention are any of the known and conventional biostatic agents, antimicrobial agents and gas-fade inhibiting agents.

Blowing agents can be of the physical and/or chemical type. Typical physical blowing agents include methylene chloride, hydrofluoroolefines, hydrofluorocarbons, clorofluorocarbons, alkanes or CO₂ which are used to provide expansion in the foaming process. A typical chemical blowing agent is water, which reacts with isocyanates in the foam, forming reaction mixture to produce carbon dioxide gas.

Other optional component(s) that could be used to prepare the composition of the present invention are known in the art and include fillers, e.g., inorganic fillers or combinations of fillers. Fillers may include those for density modification, physical property improvements such as mechanical properties or sound absorption, fire retardancy or other benefits including those that may involve improved economics such as, for example, calcium carbonate (limestone) or other fillers that reduce the cost of manufactured foam, aluminum trihydrate or other fire retardant fillers, barium sulfate (barite) or other high-density filler that is used for sound absorption, microspheres of materials such as glass or polymers that may also further reduce foam density. Fillers of high aspect ratio that are used to modify mechanical properties such as foam stiffness or flexural modulus that would include: man-made fibers such as milled glass fiber or graphite fiber: natural mineral fibers such as wollastonite: natural animal such as wool or plant fibers such as cotton: man-made plate-like fillers such as shattered glass: natural mineral plate-like fillers such as mica: possible addition of any pigments, tints or colorants.

Such optional components include other polyhydroxyl-terminated materials such as those having 2 to 8 hydroxyl groups per molecule and a molecular weight from 62 to 500 that function as crosslinkers or chain extenders. Examples of useful chain extenders having two hydroxyl groups include dipropylene glycol, diethylene glycol, 1,4-butanediol, ethylene glycol, 2,3-butanediol and neopentylglycol. Crosslinkers having 3 to 8 hydroxyl groups include glycerine, diethanolamine, pentaerythritol, mannitol, and the like.

Foams can be prepared by reacting the foam reactants under appropriate conditions to prepare a foam.

The emission control agent, presumably, removes the emission causing agents. The examples of such emission causing agents include volatiles that include, but are not limited to, formaldehyde, acetaldehyde, propionaldehyde, acrolein, etc. The emission control agent could be added to a mixture of the foam reactants. Alternatively, the emission control agent can be added to a separate composition comprising one or more of the components that will be employed in the composition for preparing the foam. In one embodiment, the emission control agent is added to a mixture of a polyol, surfactant(s), chain extender(s), crosslinker(s) and catalysts(s) prior to blending or mixing with the remaining components of the composition.

In a further embodiment, the invention provides a method for controlling emission from a polyurethane foam. The method may include contacting at least one foam reactant with an emission control agent including one or more of any of the emission control agents described above herein. In one embodiment, the method comprises contacting at least one foam reactant with an emission control agent selected from the group consisting of:

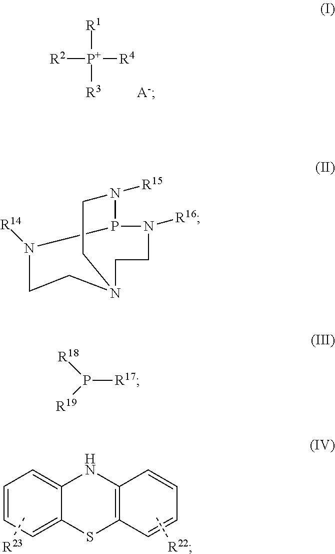

a phosphite of the formula (V-i). (V-ii). (V-iii). (V-iv). (V-v), and/or (V-vi)

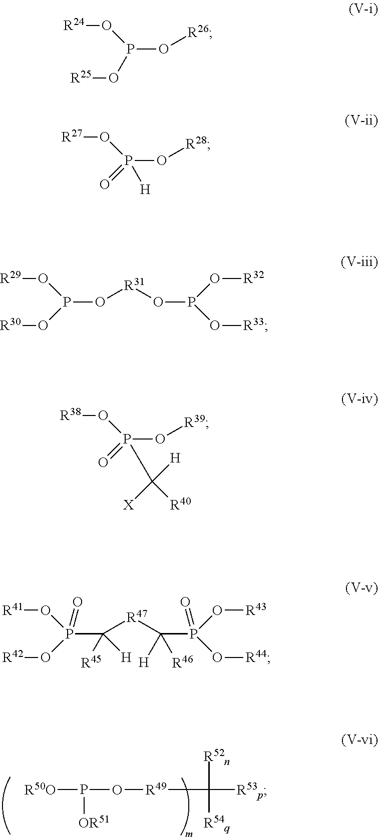

and an N-Substituted-(hydroxyalkyl) imidazolidinone, of formula (VI), or an N-substituted-(hydrocyalkyl functionalized) tetrahydro-2-pyrimidinones of formula (VII):

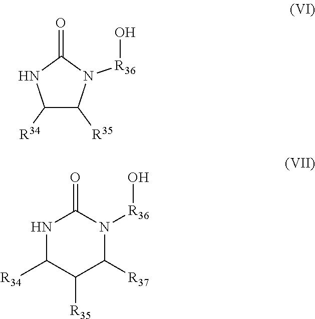

where the respective R groups are as described herein.

The compositions comprising the emission control agent have a reduced aldehyde content relative to the same composition without the emission control agent. For purposes of the present technology, the composition has a reduced aldehyde content provided at least one aldehyde species is reduced relative to a composition without the emission control agent. Further it will be appreciated that the aldehyde content of a foam composition may vary depending on the region or area where the foam is being produced or used based on the different specifications of the raw materials that may be employed or accepted in different regions/countries. Regardless of the specifications of the starting materials, the present compositions provide a reduction in one or more aldehyde species relative to the same composition without the emission control agent.

In one embodiment, the compositions and/or a foam made from such compositions has a concentration of at least one aldehyde species that is at least 5% lower, at least 10% lower, at least 15% lower, at least 20% lower, at least 25% lower, at least 30% lower, at least 40% lower, at least 50% lower, at least 60% lower, at least 70% lower, at least 75% lower, at least 80% lower, at least 90% lower, even at least 95% lower than that of the same composition without the emission control agent. In one embodiment, the composition and/or foam made from the composition has a concentration of at least one aldehyde species that is from about 5% to about 95% lower, about 10% to about 90% lower, about 20% to about 80% lower, about 25% to about 75% lower, about 30% to about 60% lower, or about 40% to about 50% lower than that of the same composition without the emission control agent. In one embodiment, at least the formaldehyde content of the composition or a foam made from the present compositions is lower than that of the same composition that does not contain the emission control agent.

Further, it will be appreciated that the present compositions may be considered effective if they reduce the concentration of one or more aldehyde species relative to a composition or foam formed from a composition that does not contain the emission control agent even if one or more other aldehyde species are not reduced in concentration or even may increase in concentration.

Additionally, it will be appreciated that the emission control agent may continue to effectively reduce or at least prevent the increase of one or more aldehyde species in the final foam product.

Aspects and embodiments of the technology are further understood with respect to the following examples.

### EXAMPLES

The following polyol blends A, B and C were used in combination with an emission control agent to prepare the composition of the present invention.

CARADOL SA34-05 is a propylene oxide and ethylene oxide based polyether triol for the production of flexible polyurethane foams such as high resilience slabstock or cold cure molding.

| | Quantity | | | |
|---|---|---|---|---|
| Component | Polyol blend A | | Polyol blend B | |
| Caradol SA34-05 | 100.0 | g | 100.0 | g |
| Water | 3.5 | g | 3.5 | g |
| A-1 | 1.0 | g | | |
| 2,(2-dimethylamino)ethoxy ethanol | | | 1.0 | g |
| Niax ™ Silicone L-3639 | 1.0 | g | 1.0 | g |
| Total | 105.5 | g | 105.5 | g |

0.5 to 5.0 pphp of the emission control agent was added to 10 grams of the polyol blend A or B, and the mixture was hermetically closed and heated to 150° C. for 30 minutes in an oil bath. The sample was then allowed to cool down to room temperature followed by injection of 3 ml of 2,4-dinitrophenylhydrazine phosphoric acid solution (concentration 0.2M, Sigma Aldrich, Cas No. 125038-14-4). The sample was heated to 50° C. for 30 minutes and subsequently analyzed by HPLC for the presence of residual aldehydes.

The control experiment was conducted without the emission control agent. The amount of aldehydes present in the polyol blend is approximately 10 ppm of formaldehyde, 20 ppm of acetaldehyde and 500 ppm of propionaldehyde.

Emission control agents were dissolved in suitable solvent prior to testing. The comparison of the efficacy of the emission control agent was made with the commercially available samples Jeffadd™ AS-53 (available from Huntsman Polyurethanes Shanghai China Ltd) and Milliguard™ AS-88 (available from Milliken Shanghai China) using the Polyol blend A. Table 1 shows the efficiency of the emission control agents relative to the control without such agents.

TABLE 1

| | | ppm | | |
|---|---|---|---|---|
| ECA | pphp | HCHO | CH₃CHO | CH₃CH₂CHO |
| Polyol blend A | | 10 | 20 | 500 |
| (without ECA) | | | | |
| Jeffadd ™ AS-53 | 0.5 | 0.1 | 19 | 490 |
| | 1 | 0.1 | 15 | 410 |
| | 5 | 0.1 | 10 | 365 |
| Milliguard ™ AS-88 | 0.5 | 4 | 12 | 435 |
| | 1 | 1 | 9 | 320 |
| | 5 | 7 | 7 | 420 |

### Examples 1-16

(2,8,9-Trimethyl-2,5,8,9-tetraaza-1-phosphabicyclo[3.3.3]undecane) (CAS RN: 120666-13-9) was purchased from Sigma Aldrich.

(Cyanomethyl) triphenylphosphonium chloride (CAS RN: 4336-70-3) was purchased from TCI Chemicals.

Methoxycarbonylmethyl) triphenylphosphonium bromide (CAS RN: 1779-58-4) was purchased from TCI Chemicals.

Tert-butylimino-tris(dimethylamino)phosphorane (CAS RN: 81675-81-2) was purchased from Sigma Aldrich.

4,4-Bis(diethylphosphonomethyl) biphenyl(BEDP) (CAS RN: 17919-34-5) was purchased from TCI Chemicals.

Dimethyl(2-oxopropyl)phosphonate (CAS RN: 4202-14-6) was purchased from TCI Chemicals.

Diethyl(4-Cyanobenzyl)phosphonate (CAS RN: 1552-41-6) was purchased from TCI Chemicals.

Diethyl(2-oxopropyl)phosphonate (CAS RN 1067-71-6) is purchased from Sigma Aldrich.

Diethylphosphonaaceticacid (CAS RN: 3095-95-2) was purchased from Sigma Aldrich.

Dimethyl 2-oxoheptylphosphonate (CAS RN: 36969-89-8) is purchased from Sigma Aldrich

Dimethyl phosphite (Cas Nr: 868-85-9) was purchased from Sigma Aldrich.

Diphenyl phosphite (Cas Nr: 4712-55-4) was purchased from Sigma Aldrich.

Triethyl phosphite (Cas Nr: 122-52-1) was purchased from Sigma Aldrich.

Triphenyl phosphite (Cas Nr: 101-02-0) was purchased from Sigma Aldrich.

9,10-Dihydro-9-oxa-10-phosphaphenanthrene 10-oxide (CAS RN. 35948-25-5) (DOPO) was purchased from TCI Chemicals.

Tris(dipropylene glycol)phosphite (CAS RN 36788-39-3) is available from Momentive Performance Materials.

Doverphos™ LGP-11 is a proprietary high molecular weight phosphite is available from Dover Chemical Corporation.

Doverphos™ LGP-12LV is high molecular weight phosphite is available from Dover Chemical Corporation.

Doverphos™ DP-253 is dioleyl hydrogen phisphite (CAS RN. 64051-29-2) is available from Dover Chemical Corporation.

Doverphos™ 374 is alkyl di-isodecyl phisphite is available from Dover Chemical Corporation.

L-Lysine (CAS RN: 56-87-1) was purchased from Sigma Aldrich.

2-Piperidine methanol (CAS RN: 3433-37-2) was purchased from Sigma Aldrich.

1-(2-Hydroxyethyl)-2-imidazolidinone (CAS RN 3699-54-5) and cyanoacetoacetamide (CAS RN 107-91-5) were purchased from Sigma Aldrich 1-(2-hydroxy ethyl) pyrrolidine (CAS RN: 3699-54-5) was purchased from Sigma Aldrich.

Copper diethyl-dithio-carbamate (CAS RN: 13681-87-3) was purchased from TCI Chemicals.

10H-Phenothiazine (CAS RN: 92-84-2) was purchased from Sigma Aldrich.

L-(+)-Arginine (CAS RN: 74-79-3), L-Cysteine (CAS RN: 52-90-4), L-Glutamine (CAS RN: 56-85-9), L-Serine (CAS RN: 56-45-1), L-(−)-Tyrosine (Cas RN: 60-18-4) were purchased from TCI Chemicals.

Compositions with Examples 1 to 5 were prepared using the polyol blend A and phosphorus based materials as the emission control agent. The results are provided in Table 2A. The amount of aldehydes present in the polyol blend A is 10 ppm formaldehyde, 20 ppm acetaldehyde and 500 ppm of propionaldehyde. Among the compositions tested, the composition containing (2,8,9-Trimethyl-2,5,8,9-tetraaza-1-phosphabicyclo[3.3.3]undecane) and cyano methyl triphenyl phosphonium chloride as emission control agent reduced at least emissions of HCHO and CH₃CHO. The composition containing methoxy carbonyl methyl triphenyl phosphonium bromide showed good control of emission for HCHO whereas 4,4bis(diethylphosphonomethyl) biphenyl(BEDP) show efficiency up to of 4.1 ppm for HCHO and 13.1 ppm for CH₃CHO respectively.

TABLE 2A

| | | ppm | | |
|---|---|---|---|---|
| ECA | pphp | HCHO | CH₃CHO | CH₃CH₂CHO |
| Polyol blend A without ECA | | 10.0 | 20.0 | 500.0 |
| Example 1 | 1.0 | 1.0 | 1.4 | 500.0 |
| (2,8,9-Trimethyl-2,5,8,9-tetraaza-1- | | | | |
| phosphabicyclo[3.3.3]undecane) | | | | |
| Example 2 | 0.5 | 0.4 | 8.4 | 430.0 |
| (Cyanomethyl)triphenylphosphonium chloride | | | | |
| Example 3 | 0.5 | 2.8 | 14.2 | 500.0 |
| (Methoxycarbonylmethyl)triphenylphosphonium bromide | | | | |
| Example 4 | 5.0 | 10.0 | 11.8 | 375.0 |
| Tert-butylimino-tris(dimethylamino)phosphorane | | | | |
| Example 5 | 0.5 | 4.1 | 13.1 | 465.0 |
| 4,4 Bis(diethylphosphonomethyl)biphenyl (BEDP) | | | | |

Furthermore, compositions with Examples 6 to 10 were prepared using the Polyol blend B and phosphorus based additional materials as the emission control agent. The results are provided in Table 2B. The amount of aldehydes present in the polyol blend B is approximately 9 ppm formaldehyde, 15 ppm acetaldehyde and 489 ppm of propionaldehyde. As is obvious from the comparative examples 6 to 10 the tested phosphorus based additives tend to reduce the levels of aldehydes.

TABLE 2B

| | | ppm | | |
|---|---|---|---|---|
| ECA | pphp | HCHO | CH₃CHO | CH₃CH₂CHO |
| Polyol blend B without ECA | | 9.3 | 15.2 | 489.0 |
| Example 6 | 0.5 | 5.7 | 7.1 | 454.7 |
| Dimethyl (2-Oxopropyl)phosphonate | | | | |
| Example 7 | 1.0 | 8.8 | 7.4 | 449.8 |
| Diethyl (4-cyanobenzyl)phosphonate | | | | |
| Example 8 | 0.5 | 5.3 | 15.2 | 469.4 |
| Diethyl (2-oxopropyl)phosphonate | | | | |
| Example 9 | 0.5 | 3.5 | 12.7 | 489 |
| Diethylphosphonoaceticacid | | | | |
| Example 10 | 0.5 | 8.0 | 15.2 | 449.8 |
| Dimethyl 2-oxoheptylphosphonate | | | | |

As is obvious from the comparative examples 10A to 10D the tested tri- and di-substituted phosphites additives tend to reduce the levels of aldehydes. Compositions with Examples 10A, 10B (diorganophosphites), and 10C, 10D (phosphite triesters) were prepared using the polyol blend A as an emission control agent. The results are provided in Table 2C. Polyol blend A tested with Examples 10A, 10B, diorganophosphites and Example 10C, 10D phosphite triesters, both performed as emission control agent and reduced the levels of acetaldehyde and especially formaldehyde compared to the blank sample (polyol blend A without ECA).

TABLE 2C

| | | Ppm | | |
|---|---|---|---|---|
| ECA | pphp | HCHO | CH₃CHO | CH₃CH₂CHO |
| Polyol blend A | | 8.4 | 15.9 | 499.8 |
| without ECA | | | | |
| Example 10A | 1.0 | 4.3 | 13.3 | 500.0 |
| Dimethyl phosphite | | | | |
| Example 10B | 1.0 | 0.1 | 13.9 | 459.8 |
| Diphenyl phosphite | | | | |
| Example 10C | 1.0 | 0.3 | 12.4 | 464.8 |
| Triethyl phosphite | | | | |
| Example 10D | 1.0 | 3.6 | 5.1 | 454.8 |
| Triphenyl phosphite | | | | |

Compositions with Example 10E, 9,10-dihydro-9-oxo-10-phosphophenanthrene-10-oxide were prepared using the Polyol blend A as an emission control agent. The detected amount of aldehydes present in the polyol blend A is 11.2 ppm formaldehyde, 17.8 ppm acetaldehyde and 522.4 ppm of propionaldehyde. Example 10E performed as emission control agent reduced the levels of propionaldehyde and especially formaldehyde, acetaldehyde compared to the blank sample (Polyol blend A without ECA). The results are provided in Table 2D.

TABLE 2D

| | | Ppm | | |
|---|---|---|---|---|
| ECA | pphp | HCHO | CH₃CHO | CH₃CH₂CHO |
| Polyol blend A | | 11.2 | 17.8 | 522.4 |
| without ECA | | | | |
| Example 10E | 1.0 | 6.0 | 5.5 | 397.0 |
| 9,10-dihydro-9-oxo-10- | | | | |
| phosphophenanthrene- | | | | |
| 10-oxide (DOPO) | | | | |

0.1 to 1.0 pphp of the Tris(dipropylene glycol)phosphite (emission control agent) was added to 10 grams of the polyol blend (Table 4A), and the mixture was hermetically closed and kept in shaker for 30 minutes followed by heating at 150° C. for 30 minutes in an oil bath. The sample was then allowed to cool to room temperature followed by injection of 3 ml of DNPH phosphoric acid solution (Prepared 0.1M DNPH concentration in the lab). The sample was heated to 50° C. for 60 minutes and was analyzed by HPLC for the presence of residual aldehydes. The control experiment was conducted without the emission control agent. The amount of aldehydes present in the polyol blend is approximately 31 ppm formaldehyde (Table 2E), 16 ppm acetaldehyde and 197 ppm propionaldehyde.

Compositions with Examples 1OF were prepared using the polyol blend C and Tris(dipropylene glycol)phosphite as the emission control agent. The results are provided in Table 2E.

TABLE 2E

| | | ppm | | |
|---|---|---|---|---|
| ECA | pphp | HCHO | CH₃CHO | CH₃CH₂CHO |
| Polyol blend C | | 30.9 | 15.8 | 196.6 |
| without ECA | | | | |
| Example 10F | 0.1 | 18.1 | 11.8 | 191.7 |
| Tris(dipropylene glycol) | | | | |
| phosphite | | | | |
| Example 10F | 0.5 | 10.2 | 10.5 | 191.9 |
| Tris(dipropylene glycol) | | | | |
| phosphite | | | | |
| Example 10F | 1.00 | 4.1 | 10.8 | 197 |
| Tris(dipropylene glycol) | | | | |
| phosphite | | | | |

Among the different compositions 0.1, 0.5 and 1.0 pphp of Tris(dipropylene glycol)phosphite tested in polyol blend C, the composition containing 0.5 and 1.0 pphp of Tris(dipropylene glycol)phosphite as emission control agent provided significant reduction of formaldehyde and partial reduction of acetaldehyde levels in comparison to the control sample.

### Examples 10G-I

1.0 pphp of the Doverphos™ materials (emission control agent) was added to 10 grams of the Polyol blend C, and the mixture was hermetically closed and kept in shaker for 30 minutes followed by heating at 150° C. for 30 minutes in an oil bath. The sample was then allowed to cool to room temperature followed by injection of 3 ml of DNPH phosphoric acid solution (Prepared 0.1M DNPH concentration in the lab). The sample was heated to 50° C. for 60 minutes and was analyzed by HPLC for the presence of residual aldehydes. The control experiment was conducted without the emission control agent. The amount of aldehydes present in the polyol blend is approximately 6.3 ppm formaldehyde, 7.3 ppm acetaldehyde and 187.2 ppm propionaldehyde.

Compositions with Examples 10G-I were prepared using the polyol blend C as the emission control agent. The results are provided in Table 2F.

TABLE 2F

| | | ppm | | |
|---|---|---|---|---|
| ECA | pphp | HCHO | CH₃CHO | CH₃CH₂CHO |
| Polyol blend C | | 6.3 | 7.3 | 187.2 |
| without ECA | | | | |
| Example 10G | 1.0 | 1.6 | 5.6 | 179.6 |
| Doverphos ™ LGP11 | | | | |
| Example 10H | 1.0 | 0.5 | 6.7 | 177.8 |
| Doverphos ™ LGP12LV | | | | |
| Example 10I | 1.0 | 3.7 | 8.7 | 178.5 |
| Doverphos ™ DP253 | | | | |

The amount of aldehydes detected in the Polyol blend C is 6.3 ppm formaldehyde, 7.3 ppm acetaldehyde and 187.2 ppm propionaldehyde. Among the Doverphos™ materials tested in Polyol blend C, Doverphos™ LGP-11 (10G) and Doverphos™ LGP-12LV (10H) provided significant reduction of formaldehyde with 1.6 and 0.5 ppm respectively. Doverphos™ DP253 (10I) demonstrated reduction of formaldehyde levels up to 3.7 ppm.

Compositions containing amino acids, amino alcohols and hydroxyfunctionalized imidazolidinone (Examples 11-14) were also tested for their emissions using the polyol blend A. The results obtained are displayed in Table 3. Among the tested compositions, the compositions containing, L-Lysine, 2-piperidine methanol, 1-(2-Hydroxyethyl)-2-imidazolidinone, and 1 (2-hydroxy ethyl) pyrrolidine as ECAs showed good efficiency for formaldehyde (1.3, 6.7, 2.6 and 3.0 ppm respectively) emissions. The compositions containing L-Lysine or 2-piperidine methanol also displayed good control of emission for acetaldehyde (5.4 and 6.0 ppm respectively). All the tested additives (Example 11-14) reduced the levels of propionaldehyde from 500 ppm to 340-390 ppm.

TABLE 3

| | | ppm | | |
|---|---|---|---|---|
| ECAs | pphp | HCHO | CH₃CHO | CH₃CH₂CHO |
| Polyol blend A | | 10 | 20 | 500 |
| without ECA | | | | |
| Example 11: | 0.5 | 1.3 | 5.4 | 340 |
| L-Lysine | | | | |
| Example 12: | 0.5 | 6.7 | 6.0 | 390 |
| 2-Piperidine methanol | | | | |
| Example 13: | 0.5 | 2.6 | 20 | 385 |
| 1-(2-Hydroxyethyl)-2- | | | | |
| imidazolidinone | | | | |
| solution (HEI) | | | | |
| Example 14: | 0.5 | 3.0 | 20 | 385 |
| 1-(2-Hydroxy ethyl) | | | | |
| pyrrolidine | | | | |

Compositions (Examples 15-16) that contain copper salts and phenothiazine-based derivatives as ECAs. The results obtained from these compositions are displayed in Table 4. Among the tested compositions, those containing copper (II) diethyldithiocarbamate showed a good emission control for formaldehyde (0.1 ppm). Interestingly, copper (II) diethyldithiocarbamate showed good efficiency for acetaldehyde (2.4 ppm) and propionaldehyde (150 ppm) reduction. 10H-Phenothiazine surprisingly reduced the levels of formaldehyde, acetaldehyde and propionaldehyde as well.

TABLE 4

| | | ppm | | |
|---|---|---|---|---|
| ECAs | pphp | HCHO | CH₃CHO | CH₃CH₂CHO |
| Polyol blend A | | 10 | 20 | 500 |
| without ECA | | | | |
| Example 15: | 0.5 | 0.1 | 2.4 | 150 |
| Copper (II) | | | | |
| diethyldithiocarbamate | | | | |
| Example 16: | 0.5 | 5.3 | 11.2 | 360 |
| 10H-Phenothiazine | | | | |

### Examples 17A-17G

The following polyol blend C was used in combination with an emission control agent to prepare the composition of the present invention.

TABLE 4A

| | Polyol blend C | |
|---|---|---|
| Component | Quantity | |
| Konix FA 703 | 70.00 | g |
| Konix FA 3630 | 30.00 | g |
| Water | 3.00 | g |
| Diethanolamine | 1.50 | g |
| Niax ™ EF-100 | 0.15 | g |
| Niax ™ EF-600 | 0.80 | g |
| Niax ™ Silicone L-3641 | 1.00 | g |
| Total | 106.45 | g |

0.5 to 1.0 pphp of the amino acids (emission control agent) was dissolved in 0.5 ml to 1.0 ml of water. The dissolved or partially dissolved amino acids were added to 10 grams of the polyol blend C, and the mixture was hermetically closed and kept in shaker for 30 minutes followed by heating at 150° C. for 30 minutes in an oil bath. The sample was then allowed to cool to room temperature followed by injection of 3 ml of DNPH phosphoric acid solution (Prepared 0.1M DNPH concentration in the lab). The sample was heated to 50° C. for 60 minutes and was analyzed by HPLC for the presence of residual aldehydes. The control experiment was conducted without the emission control agent. The amount of aldehydes present in the polyol blend is approximately 10 ppm formaldehyde, 10 ppm acetaldehyde and 300 ppm propionaldehyde.

Compositions with Examples 17A to 17F and 17G were prepared using the polyol blend C and amino acid based materials or Doverphos™ 374 as the emission control agent. The results are provided in Table 4B.

TABLE 4B

| | | ppm | | |
|---|---|---|---|---|
| ECAs | pphp | HCHO | CH₃CHO | CH₃CH₂CHO |
| Polyol blend C | | 9.6 | 9.6 | 300.0 |
| without ECA | | | | |
| Example 17A | 1.00 | 6.0 | 8.9 | 225.2 |
| L-(+)-Arginine | | | | |
| Example 17B | 1.00 | 0.2 | 28.8 | 232.5 |
| L-Cysteine | | | | |
| Example 17C | 1.00 | 6.2 | 9.1 | 243.4 |
| L-Glutamine | | | | |
| Example 17D | 1.00 | 0.9 | 9.4 | 244.0 |
| L-Lysine | | | | |
| Example 17E | 1.00 | 3.6 | 9.8 | 241.2 |
| L-Serine | | | | |
| Example 17F | 1.00 | 1.1 | 9.6 | 239.0 |
| L-(−)-Tyrosine | | | | |
| Example 17G | 1.00 | 2 | 7 | 291.0 |
| Doverphos 374 | | | | |

The amount of aldehydes present in the polyol blend is approximately 10 ppm formaldehyde, 10 ppm acetaldehyde and 300 ppm propionaldehyde. Among the compositions tested for different active sites of amino acids, the composition containing L-Cysteine (17B), L-Lysine (17D), L-(−)-Tyrosine (17F) as emission control agent recorded significant reduction of formaldehyde levels in compared to the control sample. Furthermore, the compositions containing L-(+)-Arginine (17A), L-Glutamine (17C) and L-Serine (17E) moderately reduced the levels of formaldehyde compared to the reference sample. Doverphos™ 374 (alkyl-aryl phosphite) acts as emission control agent and recorded least emissions of HCHO.

### Polyurethane Foam Evaluation

In the following examples polyurethane foams were made in accordance with the formulations summarized in Tables 5 to 14.

KONIX FA-703 is a glycerin initiated base polyether polyol with molecular weight Mw 5,100 purchased from KPX Chemical (Nanjing) Co., Ltd.

KONIX FA-3630S is a polymer polyol with solid content 30% purchased from KPX Chemical (Nanjing) Co., Ltd.

Hyperlite™ E-833 polyol is a base polyether polyol purchased from Covestro LLC.

Hyperlite™ E-852 polyol is a co-polymer polyol purchased from Covestro LLC.

DEOA is an abbreviation of diethanolamine (CAS RN. 111-42-2), and it is a viscous liquid chemical at room temperature (purity ≥99.0%, produced by a supercooling technology) purchased from Shanghai Lingfeng Chemical Reagent Co., Ltd. So it is directly added into the formulation.

Niax™ DEOA-LF is a 85 wt. % aqueous solution of diethanolamine available from Momentive Performance Materials Inc.

Niax™ Catalyst A-1 is a traditional blowing catalyst available from Momentive Performance Materials Inc.

Niax™ Catalyst A-33 is a gel catalyst available from Momentive Performance Materials Inc.

Niax™ Catalyst DMEE is a reactive PU catalyst available from Momentive Performance Materials Inc.

Niax™ Catalyst EF-150 is a low-emission blowing catalyst available from Momentive Performance Materials Inc.

Niax™ Catalyst EF-100 is a reduced emission blow catalyst available from Momentive Performance Materials Inc.

Niax™ Catalyst EF-600 is a low odor reduced emission balanced catalyst available from Momentive Performance Materials Inc.

Jeffcat™ Catalyst ZR-50 is a reactive reduced emission gel catalyst available from Huntsman Polyurethane (China) Ltd.

Niax™ Silicone L-3641 is a high potency silicone surfactant suitable for TM formulation available from Momentive Performance Materials Inc.

Niax™ Silicone L-3185 is a high potency silicone surfactant suitable for TM or TDI formulation available from Momentive Performance Materials Inc.

TM20 (TDI 80%, MDI 20%, NCO % 44.89) is a self-blended isocyanate with 80 wt % Lupranat T80 (purchased from BASF) and 20 wt % Desmodur™ 44V20L (purchased from Covestro AG).

Mondur™ TD 80 grade A is a mixture of 2,4- and 2,6 isomers of toluene diisocyanate (TDI) in the ratio of 80/20 (w/w) available from Covestro LLC.

MT30 (TDI 30%, MDI 70%, NCO % 37.36) is a self-blended isocyanate with 30 wt % Lupranat™ T80 (purchased from BASF) and 70 wt % Desmodur™ 3133 (purchased from Covestro AG).

Dipropylene glycol (DPG, CAS RN. 25265-71-8) was purchased from Shanghai Aladdin Biochemical Technology Co., Ltd.

Diethylene glycol (DEG, CAS RN. 111-46-6) was purchased from Shanghai Aladdin Biochemical Technology Co., Ltd.

9,10-Dihydro-9-oxa-10-phosphaphenanthrene 10-oxide (CAS RN. 35948-25-5) (DOPO) was purchased from Shanghai Aladdin Biochemical Technology Co., Ltd., and used as a solution in DEG.

Sodium diethyldithiocarbamate trihydrate (SDETC) (CAS RN. 20624-25-3) was purchased from Shanghai Macklin Biochemical Co., Ltd, and used as a solution in DPG.

Copper (II) diethyldithiocarbamate (CDEDTC) (CAS RN. 13681-87-3) was purchased from Shanghai Aladdin Biochemical Technology Co., Ltd, and used as a solution in DPG.

The polyurethane foams were prepared according to the following procedure. For each foam series presented in each table, first, a premix of a base polyether polyol and a polymer polyol such as KONIX FA-703/KONIX FA-3630S in Tables 5-13, and Hyperlite E-833/Hyperlite E-852 in Table 14, a crosslinker Niax™ DEOA or Niax™ DEOA-LF, a silicone stabilizer Niax™ Silicone L-3641 or NiaxIM L-3185 was prepared according to the ratios given in the tables. The premix was mixed at 4,000 rpm for 5 minutes using the Pendraulik Dissolver LR75. Next, dedicated catalyst-water catalyst blends were prepared by mixing specific amount of water and corresponding amine catalysts as follows: a) water/Niax™ Catalyst A-1/Niax™ Catalyst A-33 [C-1, C-2, C-4, C-5, C-9, C-13D, Examples 18-21, 26, 30-31, 33G], b) water/Niax™ Catalyst EF-150/Niax™ Catalyst A-33 [C-3, C-13B, Examples 22-25, 33B, 33C], c) water/Niax™ Catalyst DMEE/Niax™ Catalyst A-33 [C-6, C-7, C-8, C-10, C-11, and Example 27-29, 32], d) water/Niax EF-100/Jeffcat ZR-50 [C-12, C-13, and Example 33], e) water/Niax™ EF-150/NiaxIM EF-600 [C-13, Examples 33D-33F] and f) water/Niax™ EF-100/Niax™ EF-600 [C-14, Examples 34-35]. Following to the calculations summarized in Tables 5-14, the specified amount of the polyol premix was transferred to a plastic container, followed by the addition of the specified amount of the water/amine mixture and the resulting mixture was mixed using the Pendraulik mixing machine at 4,000 rpm for 45 seconds. Subsequently, the specified amount of an emission control agent (ECA) or an ECA solution was added to the blend mixed for further 30 seconds. Finally, the specified amount of an isocyanate (TM20 in Tables 5-12, or MT30 in Table 13, or TDI in Table 14) was added and the resulting mixture was mixed for additional 4 seconds. The mixture was then poured into a 30 cm×30 cm×10 cm temperature-controlled (65° C.) aluminum mold which was then closed. The mold's lid was fitted with 4 vents (1 mm diameter) located at each corner. The mixture expanded and filled the mold's cavity to yield a molded foam specimen. 5 minutes calculated after adding the TM20, the mold was opened and a square-shaped PU foam pad with the dimensions of 30 cm×30 cm×10 cm was demolded and used in the physical evaluations described in Tables. The following processing and physical characteristics of the foam were evaluated. Exit time is the time that was recorded from the end of mixing polyol blends and isocyanates to the first extrusion of foam from one of the vent holes.

Force-to-crush (FTC) is the peak force required to deflect a foam pad with the standard flat, circular indenter 203 mm in diameter, within 1 minute after demold, to 50% (FTC-50) or 75% (FTC-75) of its original thickness. It is measured with a load-testing machine using the same setup as the one used for a foam hardness measurement. A load tester crosshead speed of 200 mm/min is used. The FTC value is a good relative measure of the degree of cell openness characteristic of foam, i.e., the lower the value, the more open the foam.

Hot indentation load deflection (Hot ILD) is measured on the same pad used for the FTC measurement within 3 minutes after demold. Following the FTC measurement, the foam pad is completely crushed by a mechanical crusher before the measurement of Hot-ILD-50% (at 50% compression) or Hot-ILD-75% (at 75% compression) is taken. The Hot ILD value is a good relative measure of the curing degree of a foam at 3 minutes after demolding. The higher the Hot ILD value, the higher the cure degree of foam.

Indentation Force Deflection (IFD-25%) is a parameter that provides information about foam firmness. The higher the IFD value, the firmer the foam. The detailed test procedure of IFD is described in ASTM D3574 Test B1.

Aldehyde emission results in polyurethane foams are measured according to recommendations of the Toyota TSM0508G: Volatile component measurement method using sampling bag. The polyurethane foam should be produced within 14 days before the test and needs to be crushed to open cells before cutting into a specific cubic 30 gram test specimen. After weighing the test specimen, it was placed in selected 10 L Tedlar gas bags (SMAETBAG from GL Science) that had previously been pretreated by a hot washing method and passed the blank values limitation requirement. The bag with the foam sample was sealed and then filled with approximately 5 L of nitrogen gas. The nitrogen gas was removed with aspiration as a next step to check for possible leaks. The bag was subsequently filled with 5 L nitrogen gas by accurately measuring the quantity with a gas flowmeter, and the stop valves connected to the Tedlar bag were closed. The bag with a foam specimen was placed in a thermostatic oven that had been maintained at 65° C. Under this condition, the bag was maintained at 65° C. for 2 hours, the gas was then pumped out through a 300 mg 2,4-dinitrophenylhydrazine (DNPH) cartridge to capture the carbonyl compounds. The gas that has been sampled in the DNPH cartridge was extracted using acetonitrile as a solvent. The extracted acetonitrile solution was analyzed using Agilent HPLC 1200 equipped with a UV/vis detector (G1315B DAB at 360) nm). The injection volume was 5 μL on Agilent Poroshell 120EC-C18 75×4.6 mm, 2.7 μm chromatographic column with acetonitrile: water gradient elution to quantify the respective DNPH-hydrazones.

The emissions of formaldehyde, acetaldehyde and propionaldehyde for each of comparative samples and examples are listed in Tables 5-12. Experimental foam series in each table were conducted on the same day and the foams were treated the same way to provide representative tendencies.

TABLE 5

| | Example C-1 | | | |
|---|---|---|---|---|
| | (reference) | Example 18 | Example 19 | Example 20 |
| | pphp | pphp | pphp | pphp |
| Raw Materials | | | | |
| KONIX FA-703 | 70.00 | 70.00 | 70.00 | 70.00 |
| KONIX FA-3630S | 30.00 | 30.00 | 30.00 | 30.00 |
| Water | 3.50 | 3.50 | 3.50 | 3.50 |
| DEOA | 1.50 | 1.50 | 1.50 | 1.50 |
| Niax ™ Catalyst A-1 | 0.09 | 0.09 | 0.09 | 0.09 |
| Niax ™ Catalyst A-33 | 0.37 | 0.37 | 0.37 | 0.37 |
| Niax ™ Silicone L-3641 | 1.00 | 1.00 | 1.00 | 1.00 |
| Diethyl (2-oxopropyl)phosphonate | | 0.10 | 0.50 | 1.00 |
| TM20 (NCO % 44.89) | 46.89 | 46.89 | 46.89 | 46.89 |
| Index | 102 | 102 | 102 | 102 |
| Processing parameters of PU foam | | | | |
| Exit Time [s] | 34 | 34 | 34 | 34 |
| FTC-75% [N] | 2073 | 2203 | 2100 | 2145 |
| Hot ILD-75% [N] | 622 | 662 | 613 | 651 |
| IFD-25%[N] | 129 | 135 | 134 | 128 |
| Pad Weight [g] | 397 | 397 | 398 | 400 |
| Density of the foam pad [kg/m³] | 0.44 | 0.44 | 0.44 | 0.44 |
| PU foam aldehyde emissions | | | | |
| Formaldehyde [mg/m³] | 0.045 | 0.023 | 0.016 | 0.013 |
| Acetaldehyde [mg/m³] | 0.030 | 0.028 | 0.034 | 0.030 |
| Propionaldehyde [mg/m³] | 0.096 | 0.085 | 0.085 | 0.087 |

As the data shown in Table 5 comparing example CI to Examples 18-20, it can be seen that the formaldehyde emissions is reduced from 0.045 to 0.023 mg/m3 when adding 0.1 pphp of diethyl(2-oxopropyl)phosphonate, and the most significant reduction of formaldehyde emission was accomplished with diethyl(2-oxopropyl)phosphonate at 1.0 pphp as the emission control agent: 0.013 mg/m3. Meanwhile the molded foam evaluation parameters such as Exit Time, FTC, Hot-ILD, and IFD-25% results show that diethyl(2-oxopropyl)phosphonate has no negative impact on both the foaming process and foam mechanical properties.

TABLE 6

| | Example C-2 | |
|---|---|---|
| | (reference) | Example 21 |
| | pphp | pphp |
| Raw Materials | | |
| KONIX FA-703 | 70.00 | 70.00 |
| KONIX FA-3630S | 30.00 | 30.00 |
| Water | 3.50 | 3.50 |
| DEOA | 1.50 | 1.50 |
| Niax ™ Catalyst A-1 | 0.09 | 0.09 |
| Niax ™ Catalyst A-33 | 0.37 | 0.37 |
| Niax ™ Silicone L-3641 | 1.00 | 1.00 |
| Dimethyl (2-oxoheptyl) phosphonate | | 0.10 |
| TM20 (NCO % 44.89) | 46.89 | 46.89 |
| Index | 102 | 102 |
| Processing parameters of PU foam | | |
| Exit Time [s] | 36 | 38 |
| FTC-75% [N] | 1352 | 988 |
| Hot ILD-75% [N] | 562 | 494 |
| IFD-25%[N] | 131 | 132 |
| Pad Weight [g] | 396 | 395 |
| Density of the foam pad [kg/m³] | 0.44 | 0.44 |
| PU foam aldehyde emissions | | |
| Formaldehyde [mg/m³] | 0.0634 | 0.0336 |
| Acetaldehyde [mg/m³] | 0.0485 | 0.0589 |
| Propionaldehyde [mg/m³] | 0.0175 | 0.0191 |

Table 6 shows that dimethyl(2-oxoheptyl)phosphonate acts as an emission control agent to reduce formaldehyde emission from 0.0634 to 0.0336 mg/m3 compared to the reference sample with only a minor detrimental impact on the foaming process and no impact on the foam mechanical properties, which lead to decreased FTC-75% value and comparable IFD-25% value compared to the reference sample.

TABLE 7

| | Example C-3 | | | | |
|---|---|---|---|---|---|
| | (reference) | Example 22 | Example 23 | Example 24 | Example 25 |
| | pphp | pphp | pphp | pphp | pphp |
| Raw Materials | | | | | |
| KONIX FA-703 | 70.00 | 70.00 | 70.00 | 70.00 | 70.00 |
| KONIX FA-3630S | 30.00 | 30.00 | 30.00 | 30.00 | 30.00 |
| Water | 4.00 | 4.00 | 4.00 | 4.00 | 4.00 |
| DEOA | 1.50 | 1.50 | 1.50 | 1.50 | 1.50 |
| Niax ™ Catalyst EF-150 | 0.22 | 0.22 | 0.22 | 0.22 | 0.22 |
| Niax ™ Catalyst A-33 | 0.45 | 0.45 | 0.45 | 0.45 | 0.45 |
| Niax ™ Silicone L-3641 | 1.00 | 1.00 | 1.00 | 1.00 | 1.00 |
| 4,4-bis (diethyl phosphonomethyl) | | 0.50 | | 2.50 | |
| biphenyl solution | | | | | |
| Gamma-butyrolactone | | | 0.40 | | 2.00 |
| TM20 (NCO % 44.89) | 52.19 | 52.19 | 52.19 | 52.19 | 52.19 |
| Index | 102 | 102 | 102 | 102 | 102 |
| Processing parameters of PU foam | | | | | |
| Exit Time [s] | 33 | 33 | 33 | 33 | 34 |
| FTC-75% [N] | 1270 | 1061 | 1274 | 1386 | 1374 |
| Hot ILD-75% [N] | 545 | 521 | 545 | 507 | 515 |
| IFD-25%[N] | 144 | 142 | 143 | 128 | 125 |
| Pad Weight [g] | 370 | 372 | 370 | 372 | 372 |
| Density of the foam pad [kg/m³] | 0.41 | 0.41 | 0.41 | 0.41 | 0.41 |
| PU foam aldehyde emissions | | | | | |
| Formaldehyde [mg/m³] | 0.0533 | 0.0210 | 0.0517 | 0.0221 | 0.0517 |
| Acetaldehyde [mg/m³] | 0.0267 | 0.0267 | 0.0267 | 0.0292 | 0.0308 |
| Propionaldehyde [mg/m³] | 0.0133 | 0.0125 | 0.0125 | 0.0125 | 0.0133 |

4,4-Bis(diethyl phosphonomethyl) biphenyl was used as a 20 wt % gamma-butyrolactone solution in the formulation.

As can be seen by the data listed in Table 7, 4,4-bis(diethyl phosphonomethyl) biphenyl offers efficient formaldehyde emission control performance in a molded TM20 polyurethane foam application, providing reduction in formaldehyde emissions from 0.0533 to 0.0210 mg/m3. Furthermore, it was shown that 4,4-bis —(diethyl phosphonomethyl)-biphenyl had no impact on exit time, FTC-75% value, Hot-ILD-75% and IFD-25% indicating no negative impact on foaming properties and foam mechanical properties.

We found the phosphorous-based emission control agents beneficially have no contribution to unpleasant foam odor unlike cyanoacetoactamide and diethyl malonate as described in US 2016/0304686 A1.

TABLE 8

| | Example C-4 | | Example C-5 |
|---|---|---|---|
| | (reference) | Example 26 | (comparative) |
| | pphp | pphp | pphp |
| Raw Materials | | | |
| KONIX FA-703 | 70.00 | 70.00 | 70.00 |
| KONIX FA-3630S | 30.00 | 30.00 | 30.00 |
| Water | 3.50 | 3.33 | 0.67 |
| DEOA | 1.50 | 1.50 | 1.50 |
| Niax ™ Catalyst A-1 | 0.09 | 0.09 | 0.09 |
| Niax ™ Catalyst A-33 | 0.37 | 0.37 | 0.37 |
| Niax ™ Silicone L-3641 | 1.00 | 1.00 | 1.00 |
| 75 wt % 1-(2-hydroxyethyl)-2-imidazolidinone | | 0.67 | |
| water solution | | | |
| 15 wt % cyanoacetoactamide water solution | | | 3.33 |
| TM20 (NCO % 44.89) | 46.89 | 46.89 | 46.89 |
| Index | 102 | 102 | 102 |
| Processing parameters of PU foam | | | |
| Exit Time [s] | 40 | 40 | Foam |
| FTC-75% [N] | 1059 | 617 | Collapse |
| Hot ILD-75% [N] | 541 | 634 | |
| IFD-25%[N] | 161 | 142 | |
| Pad Weight [g] | 411 | 410 | |
| Density of the foam pad [kg/m³] | 0.46 | 0.46 | |
| PU foam aldehyde emissions | | | |
| Formaldehyde [mg/m³] | 0.0462 | 0.0186 | |
| Acetaldehyde [mg/m³] | 0.0384 | 0.0372 | |
| Propionaldehyde [mg/m³] | 0.0106 | 0.0099 | |

1-(2-hydroxyethyl)-2-imidazolidinone was used as 75 wt % aqueous solution in the foam formulation. Table 8 shows that 1-(2-hydroxyethyl)-2-imidazolidinone provided reduction in formaldehyde emissions from 0.0462 to 0.0186 mg/m3 compared to the reference sample. We observed a minor negative impact on the foaming process and no impact on the foam mechanical properties (decreased FTC-75% value and comparable IFD-25% value compared to the reference sample). Example C-5 is a comparative example adding cyanoacetoactamide that was described in US 2016/0304686 A1. As shown in the Table 8, cyanoacetoactamide has a significant negative impact on the foaming process and the addition of cyanacetoacetamide (as a 15 wt % aqueous solution) lead to a total foam collapse (Example C-5).

TABLE 9

| | Example C-6 | Example C-7 | | |
|---|---|---|---|---|
| | (reference) | (reference) | Example 27 | Example 28 |
| | pphp | pphp | pphp | pphp |
| Raw Materials | | | | |
| KONIX FA-703 | 70.00 | 70.00 | 70.00 | 70.00 |
| KONIX FA-3630S | 30.00 | 30.00 | 30.00 | 30.00 |
| Water | 3.50 | 3.50 | 3.50 | 3.50 |
| DEOA | 1.50 | 1.50 | 1.50 | 1.50 |
| Niax ™ Catalyst DMEE | 0.36 | 0.36 | | |
| Niax ™ Catalyst A-33 | 0.37 | 0.37 | 0.37 | 0.37 |
| Niax ™ Silicone L-3641 | 1.00 | 1.00 | 1.00 | 1.00 |
| (Cyanomethyl)triphenylphosphonium | | | 0.41 | 0.41 |
| chloride solution | | | | |
| TM20 (NCO % 44.89) | 47.19 | 47.19 | 47.19 | 47.19 |
| Index | 102 | 102 | 102 | 102 |
| Processing parameters of PU foam | | | | |
| Exit Time [s] | 34 | 35 | 35 | 34 |
| FTC-50% [N] | 887 | 859 | 776 | 767 |
| Hot ILD-50% [N] | 197 | 189 | 186 | 181 |
| Pad Weight [g] | 400 | 40 | 396 | 397 |
| Density of the foam pad [kg/m³] | 0.44 | 0.44 | 0.44 | 0.44 |
| PU foam aldehyde emissions | | | | |
| Formaldehyde [mg/m³] | 0.1090 | 0.0976 | 0.0894 | 0.0874 |
| Acetaldehyde [mg/m³] | 0.0990 | 0.0951 | 0.0757 | 0.0705 |
| Acrolein [mg/m³] | 0.0793 | 0.0799 | 0.0634 | 0.0668 |
| Propionaldehyde [mg/m³] | 0.0378 | 0.0362 | 0.0357 | 0.0359 |

(Cyanomethyl) triphenylphosphonium chloride was used as a 2.12 wt % solution in DMEE. The dosage of DMEE in formulations C-6, C-7, Example 27 and 28 are constant. The resulting calculated use level of (cyanomethyl) triphenylphosphonium chloride in the foam formulation was 0.05 pphp. As shown in the Table 9, duplicate experiments were performed for this comparative example. The addition of (cyanomethyl) triphenylphosphonium chloride lead to a reduction of formaldehyde, acetaldehyde and acrolein emissions from the foam sample compared to the reference examples C-6 and C-7. As shown in Table 9, exit time, FTC-50%, Hot ILD-50% and pad weight indicate that there was no significant effect on the foaming properties and foaming process, providing an additional improvement over current technology.

TABLE 10

| | Example C-8 | |
|---|---|---|
| | (reference) | Example 29 |
| | pphp | pphp |
| Raw Materials | | |
| KONIX FA-703 | 70.00 | 70.00 |
| KONIX FA-3630S | 30.00 | 30.00 |
| Water | 3.50 | 3.50 |
| DEOA | 1.50 | 1.50 |
| Niax ™ Catalyst DMEE | 0.36 | |
| Niax ™ Catalyst A-33 | 0.37 | 0.37 |
| Niax ™ Silicone L-3641 | 1.00 | 1.00 |
| (Methoxycarbonylmethyl)triphenylphosphonium | | 0.387 |
| bromide solution | | |
| TM20 (NCO % 44.89) | 47.19 | 47.19 |
| Index | 102 | 102 |
| Processing parameters of PU foam | | |
| Exit Time [s] | 35 | 35 |
| FTC-50% [N] | 873 | 743 |
| Hot ILD-50% [N] | 193 | 188 |
| Pad Weight [g] | 401 | 398 |
| Density of the foam pad [kg/m³] | 0.45 | 0.44 |
| PU foam aldehyde emissions | | |
| Formaldehyde [mg/m³] | 0.1030 | 0.0417 |
| Acetaldehyde [mg/m³] | 0.0870 | 0.0550 |
| Acrolein [mg/m³] | 0.0796 | 0.0685 |
| Propionaldehyde [mg/m³] | 0.0370 | 0.0281 |

(Methoxycarbonylmethyl) triphenylphosphonium bromide was also used as a DMEE solution (5.21 wt %). The use levels of DMEE in formulations C-8 and, Example 29 are constant. The calculated dosage of (methoxycarbonylmethyl) triphenylphosphonium bromide in the formulation was 0.027 pphp. As shown by comparison of the inventive Example 29 and the reference sample C-8 (Table 10) (methoxycarbonylmethyl) triphenylphosphonium bromide reduced both formaldehyde and acetaldehyde emissions from 0.1030 to 0.0417, and from 0.0870 to 0.0550 mg/m3, respectively. Reduction of acrolein and propionaldehyde emissions from the foam specimens was also observed when compared with the reference sample. The exit time, FTC-50% and Hot ILD-50% results indicated that (methoxycarbonylmethyl) triphenylphosphonium bromide had a minor detrimental impact on the foaming process and foam properties.

TABLE 11

| | Example C-9 | | |
|---|---|---|---|
| | (reference) | Example 30 | Example 31 |
| | pphp | pphp | pphp |
| Raw Materials | | | |
| KONIX FA-703 | 70.00 | 70.00 | 70.00 |
| KONIX FA-3630S | 30.00 | 30.00 | 30.00 |
| Water | 3.50 | 3.50 | 3.50 |
| DEOA | 1.50 | 1.50 | 1.50 |
| Niax ™ Catalyst A-1 | 0.09 | 0.09 | 0.09 |
| Niax ™ Catalyst A-33 | 0.37 | 0.37 | 0.37 |
| Niax ™ Silicone L-3641 | 1.00 | 1.00 | 1.00 |
| Dimethyl (2-oxopropyl) phosphonate | | 0.1 | 0.5 |
| TM20 (NCO % 44.89) | 46.89 | 46.89 | 46.89 |
| Index | 102 | 102 | 102 |
| Processing parameters of PU foam | | | |
| Exit Time [s] | 34 | 34 | 34 |
| FTC-50% [N] | 360 | 223 | 65 |
| Hot ILD-50% [N] | 148 | 118 | 76 |
| Pad Weight [g] | 393 | 394 | 392 |
| Density of the foam pad [kg/m³] | 0.44 | 0.44 | 0.44 |
| PU foam aldehyde emissions | | | |
| Formaldehyde [mg/m³] | 0.0937 | 0.0790 | 0.0723 |
| Acetaldehyde [mg/m³] | 0.1270 | 0.1350 | 0.236 |
| Acrolein [mg/m³] | 0.0977 | 0.1640 | 0.325 |
| Propionaldehyde [mg/m³] | 0.0628 | 0.0512 | 0.237 |

Dimethyl 2-oxopropylphosphonate is a liquid and was therefore applied neat directly in the formulation. The data in Table 11 compare example C-9 to Examples 30-31, are showing a reduction of formaldehyde emissions when 0.5 pphp dimethyl 2-oxopropylphosphonate was added to the formulation. Table 1 shows reduction of FTC and Hot-ILD values in the foam samples prepared with dimethyl 2-oxopropylphosphonate indicating an undesired interference with the foaming process.

TABLE 12

| | Example C-10 | Example C-11 | |
|---|---|---|---|
| | (reference) | (reference) | Example 32 |
| | pphp | pphp | pphp |
| Raw Materials | | | |
| KONIX FA-703 | 70.00 | 70.00 | 70.00 |
| KONIX FA-3630S | 30.00 | 30.00 | 30.00 |
| Water | 3.50 | 3.50 | 3.50 |
| DEOA | 1.50 | 1.50 | 1.50 |
| Niax ™ Catalyst DMEE | 0.36 | 0.36 | 0.36 |
| Niax ™ Catalyst A-33 | 0.37 | 0.37 | 0.37 |
| Niax ™ Silicone L-3641 | 1.00 | 1.00 | 1.00 |
| Propylene carbonate (PC) | | 0.90 | |
| Diethyl (4-cyanobenzyl) phosphonate solution | | | 1.00 |
| TM20 (NCO % 44.89) | 46.89 | 46.89 | 46.89 |
| Index | 102 | 102 | 102 |
| Processing parameters of PU foam | | | |
| Exit Time [s] | 35 | 35 | 35 |
| FTC-50% [N] | 873 | 898 | 871 |
| Hot ILD-50% [N] | 193 | 182 | 191 |
| Pad Weight [g] | 401 | 402 | 402 |
| Density of the foam pad [kg/m³] | | | |
| PU foam aldehyde emissions | | | |
| Formaldehyde [mg/m³] | 0.1030 | 0.1030 | 0.0844 |
| Acetaldehyde [mg/m³] | 0.0870 | 0.0770 | 0.0718 |
| Acrolein [mg/m³] | 0.0796 | 0.0876 | 0.0789 |
| Propionaldehyde [mg/m³] | 0.0370 | 0.0313 | 0.0327 |

Diethyl(4-cyanobenzyl)phosphonate was applied as a solution (9.82 wt %) in propylene carbonate (PC) and was used at 0.1 pphp in the foam formulation. As the data shown in Table 12, diethyl(4-cyanobenzyl)phosphonate reduced formaldehyde emissions compared to the reference sample C-10 and C-11 in the TM20 molded polyurethane foam formulation. In addition, no negative impact on the foaming process was observed in foam samples prepared with diethyl(4-cyanobenzyl)phosphonate.

TABLE 13A

| | Example C-12 | Example C-13 | |
|---|---|---|---|
| | (reference) | (reference) | Example 33 |
| | pphp | pphp | pphp |
| Raw Materials | | | |
| KONIX FA-703 | 70.00 | 70.00 | 70.00 |
| KONIX FA-3630S | 30.00 | 30.00 | 30.00 |
| Water | 3.60 | 3.60 | 3.60 |
| DEOA | 1.20 | 1.20 | 1.20 |
| Niax ™ Catalyst EF-100 | 0.16 | 0.16 | 0.16 |
| Jeffcat ™ Catalyst ZR-50 | 0.45 | 0.45 | 0.45 |
| Niax ™ Surfactant L-3641 | 0.80 | 0.80 | 0.80 |
| Diethylene glycol (DEG) | | 0.90 | |
| 9,10-Dihydro-9-oxa-10- | | | 1.00 |
| phosphaphenanthrene 10-oxide | | | |
| solution (10 wt % in DEG) | | | |
| MT30 (NCO % 37.36) | 52.80 | 52.80 | 52.80 |
| Index | 95 | 95 | 95 |
| PU foam physical properties | | | |
| Exit Time [s] | 41 | 41 | 43 |
| FTC-50% [N] | 2416 | 2147 | 1566 |
| Hot ILD-50% [N] | 628 | 608 | 568 |
| IFD-25% [N] | 160 | 15 | 147 |
| Pad Weight [g] | 420 | 425 | 425 |
| Density of the foam pad [kg/m³] | 47 | 47 | 47 |
| PU foam aldehyde emissions | | | |
| Formaldehyde [mg/m³] | 0.1550 | 0.2074 | 0.1742 |
| Acetaldehyde [mg/m³] | 0.0934 | 0.0896 | 0.0875 |
| Acrolein [mg/m³] | 0.0588 | 0.0617 | 0.0600 |
| Propionaldehyde [mg/m³] | 0.0560 | 0.0565 | 0.0544 |

9,10-Dihydro-9-oxa-10-phosphaphenanthrene 10-oxide was used as a solution (10 wt %) in diethylene glycol (DEG). As the data shown in Table 13A comparing to example C-13 to Examples 33, it can be seen that 9,10-Dihydro-9-oxa-10-phosphaphenanthrene 10-oxide offers formaldehyde emission control performance in MT30 molded polyurethane application, which leads to a reduction of formaldehyde emissions from 0.2074 to 0.1742 mg/m³ when used at 1.0 pphp of 9,10-Dihydro-9-oxa-10-phosphaphenanthrene 10-oxide solution (calculated 9,10-Dihydro-9-oxa-10-phosphaphenanthrene 10-oxide dosage 0.1 pphp) in the final formulation. Meanwhile, the molded foam evaluation parameters such as Exit Time, FTC, Hot-ILD, and IFD-25% results show that 9,10-Dihydro-9-oxa-10-phosphaphenanthrene 10-oxide has no detrimental impact on foaming process and foam mechanical properties.

7-[2-(2-hydroxymethylethoxy) methylethoxy]tetramethyl-3,6,8,11-tetraoxa-7-phosphatridecane-1,13-diol (CAS RN. 36788-39-3) is a liquid and was therefore applied neat directly in the formulation at 0.1 and 0.5 pphp amounts (Table 13B).

TABLE 13B

| | Example C-13B | | |
|---|---|---|---|
| | (reference) | Example 33B | Example 33C |
| | pphp | pphp | pphp |
| Raw Materials | | | |
| KONIX FA-703 | 70.00 | 70.00 | 70.00 |
| KONIX FA-3630S | 30.00 | 30.00 | 30.00 |
| Water | 4.0 | 4.0 | 4.0 |
| DEOA | 1.50 | 1.50 | 1.50 |
| Niax ™ Catalyst EF-150 | 0.22 | 0.22 | 0.22 |
| Niax ™ Catalyst A-33 | 0.45 | 0.45 | 0.45 |
| Niax ™ Surfactant L-3641 | 1.00 | 1.00 | 1.00 |
| Tris(dipropylene glycol) phosphite | | 0.10 | 0.50 |
| (CAS RN. 36788-39-3) | | | |
| TM20 (NCO % 44.89) | 52.19 | 52.19 | 52.19 |
| Index | 102 | 102 | 102 |
| Processing parameters of PU foam | | | |
| Exit Time [s] | 30 | 31 | 31 |
| FTC-75% [N] | 1056.0 | 1294.0 | 1358.0 |
| Hot ILD-75% [N] | 482.0 | 559.0 | 518.0 |
| Pad Weight [g] | 366.1 | 368.4 | 370.2 |
| Density of the foam pad [kg/m³] | 40.67 | 40.92 | 41.10 |
| Aldehyde emissions from PU foam | | | |
| Formaldehyde [mg/m³] | 0.0442 | 0.0292 | 0.0258 |
| Acetaldehyde [mg/m³] | 0.0383 | 0.0318 | 0.0310 |
| Propionaldehyde [mg/m³] | 0.0117 | 0.0142 | 0.0183 |

As shown by comparison of the Examples 33B and the reference sample C-13B in Table 13B, addition of 0.1 pphp Tris(dipropylene glycol)phosphite (CAS RN. 36788-39-3) reduced formaldehyde emissions from 0.0442 to 0.0292, and from 0.0383 to 0.0258 mg/m³. Increasing the amount of the additive from 0.1 to 0.5 pphp reduced the formaldehyde level even to 0.0258 mg/m³. Meanwhile, the exit times were not impacted, whereas FTC and Hot ILD results indicate that Tris(dipropylene glycol)phosphite contributed to increased FTC and hot ILD values.

In additional series of experiments (Table 13C, Example 33D and 33E) it was found that the addition of phosphites Doverphos™ DP 253 and Doverphos™ LGP11 moderately reduced the formaldehyde level of the comparative foam from 0.1620 to 0.1439 and 0.1133 mg/m³. The addition of Tris(dipropylene glycol)phosphite significantly reduced the level of formaldehyde from 0.1620 to 0.0435 mg/m³.

TABLE 13C

| | Example C-13C | | | |
|---|---|---|---|---|
| | (reference) | Example 33D | Example 33E | Example 33F |
| | pphp | pphp | pphp | pphp |
| Raw Materials | | | | |
| KONIX FA-703 | 70.00 | 70.00 | 70.00 | 70.00 |
| KONIX FA-3630S | 30.00 | 30.00 | 30.00 | 30.00 |
| Water (Added) | 3.38 | 3.38 | 3.38 | 3.38 |
| DEOA-LF | 1.20 | 1.20 | 1.20 | 1.20 |
| Niax ™ Catalyst EF-150 | 0.22 | 0.22 | 0.22 | 0.22 |
| Niax ™ Catalyst EF-600 | 1.20 | 1.20 | 1.20 | 1.20 |
| Niax ™ Surfactant L-3641 | 1.00 | 1.00 | 1.00 | 1.00 |
| Doverphos ™ DP253 | | 0.50 | | |
| Doverphos ™ LGP11 | | | 0.50 | |
| Tris(dipropylene glycol) phosphite | | | | 0.50 |
| (CAS RN. 36788-39-3) | | | | |
| TM20 (NCO % 44.89) | 46.59 | 46.49 | 46.59 | 46.59 |
| Index | 102 | 102 | 102 | 102 |
| Processing parameters of PU foam | | | | |
| Exit Time [s] | 31 | 31 | 30 | 30 |
| FTC-75% [N] | 2102 | 1842 | 2653 | 2212 |
| Hot ILD-75% [N] | 521 | 512 | 676 | 520 |
| IFD-25% [N] | 139 | 141 | 137 | 142 |
| Pad Weight [g] | 368.0 | 369.3 | 371.1 | 367.5 |
| Density of the foam pad [kg/m³] | 40.89 | 41.03 | 41.23 | 40.83 |
| Aldehyde emissions from PU foam | | | | |
| Formaldehyde [mg/m³] | 0.1620 | 0.1439 | 0.1133 | 0.0435 |
| Acetaldehyde [mg/m³] | 0.0428 | 0.0432 | 0.0568 | 0.0406 |
| Propionaldehyde [mg/m³] | 0.0195 | 0.0256 | 0.0423 | 0.0316 |

The beneficial impact of Tris(dipropylene glycol)phosphite is also observed by comparative experiments shown in Table 13D, where the addition of Tris(dipropylene glycol) phosphite (Example 33G) reduced the level of formaldehyde from 0.0556 mg/m³ to none detectible range 0 mg/m³. Emission control of acetaldehyde was observed as well by reduction of it's emission from 0.0561 to 0.0400 mg/m³.

TABLE 13D

| | Example C-13D | |
|---|---|---|
| | (reference) | Example 33G |
| | pphp | pphp |
| Raw Materials | | |
| KONIX FA-703 | 70.00 | 70.00 |
| KONIX FA-3630S | 30.00 | 30.00 |
| Water (Added) | 3.39 | 3.39 |
| DEOA-LF | 1.41 | 1.41 |
| Niax ™ Catalyst A-1 | 0.09 | 0.09 |
| Niax ™ Catalyst A-33 | 0.35 | 0.35 |
| Niax ™ Surfactant L-3636 | 0.80 | 0.80 |
| Tris(dipropylene glycol) phosphite | | 0.50 |
| (CAS RN. 36788-39-3) (CAS RN. 36788-39-3) | | |
| MT30 (NCO % 37.36) | 52.84 | 52.84 |
| Index | 95 | 95 |
| Processing parameters of PU foam | | |
| Exit Time [s] | 41 | 42 |
| FTC-75% [N] | 2146 | 2275 |
| Hot ILD-75% [N] | 560 | 625 |
| IFD-25% [N] | 173 | 172 |
| Pad Weight [g] | 419.4 | 421.6 |
| Density of the foam pad [kg/m³] | 46.60 | 46.84 |
| Aldehyde emissions from PU foam | | |
| Formaldehyde [mg/m³] | 0.0556 | 0 |
| Acetaldehyde [mg/m³] | 0.0561 | 0.0400 |
| Propionaldehyde [mg/m³] | 0.0331 | 0.0577 |

Sodium diethyldithiocarbamate trihydrate (SDETC) and copper (II) diethyldithiocarbamate (CDEDTC) are solids and were dissolved in DPG at room temperature upon stirring to obtain concentration of 1.22, and 2.54 wt % respectively, in DPG. The calculated dosage of SDETC and CDEDTC in the formulation is 0.012 and 0.025 pphp corresponds to 100 ppm in the final foam specimen.

TABLE 14

| | Example C-14 | | |
|---|---|---|---|
| | (reference) | Example 34 | Example 35 |
| | pphp | pphp | pphp |
| Raw Materials | | | |
| Hyperlite E-833 Polyol | 90.00 | 90.00 | 90.00 |
| Hyperlite E-852 Polyol | 10.00 | 10.00 | 10.00 |
| Water (added) | 3.06 | 3.05 | 3.06 |
| Niax ™ DEOA-LF | 1.65 | 1.65 | 1.65 |
| Niax ™ Catalyst EF-100 | 0.25 | 0.25 | 0.25 |
| Niax ™ Catalyst EF-600 | 0.98 | 0.98 | 0.98 |
| Niax ™ Surfactant L-3185 | 1.00 | 1.00 | 1.00 |
| Sodium diethyldithiocarbamate trihydrate | | 1.00 | |
| solution (1.22 wt % in DPG) | | | |
| Copper(II) diethyldithiocarbamate solution | | | 1.00 |
| (2.54 wt % in DPG) | | | |
| Mondur TD 80 Grade A (NCO % approx. 48) | 41.47 | 41.38 | 41.47 |
| Index | 105 | 105 | 105 |
| PU foam physical properties | | | |
| Exit Time [s] | 50 | 48 | 54 |
| FTC-75% [N] | 1579 | 1838 | 1580 |
| Hot ILD-75% [N] | 148 | 166 | 154 |
| Pad Weight [g] | 518 | 522 | 516 |
| Density of the foam pad [kg/m³] | 35 | 35 | 35 |
| PU foam aldehyde emissions | | | |
| Formaldehyde [mg/m³] | 0.0980 | 0.0718 | 0.0428 |
| Acetaldehyde [mg/m³] | 0.0829 | 0.0993 | 0.1215 |
| Acrolein [mg/m³] | 0.0428 | 0.0642 | 0.0633 |
| Propionaldehyde [mg/m³] | 0.0290 | 0.0314 | 0.0303 |

As shown by comparison of the Examples 34, 35, and the reference sample C-14 in Table 14, both SDETC and CDEDTC significantly reduced formaldehyde emissions from 0.0980 to 0.0718, and from 0.0980 to 0.0428 mg/m³, respectively. Meanwhile, the exit time, FTC and Hot ILD results indicate that both SDETC and CDEDTC have no detrimental impact on foaming process and foam properties.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a method of treating a composition containing one or more aldehyde species to reduce the concentration of at least one of the one or more aldehyde species. Modifications may occur to those skilled in the art and to those who may make and use the invention. The disclosed embodiments are merely for illustrative purposes and not intended to limit the scope of the invention or the subject matter set forth in the claims.

1. A composition comprising:
a) at least one foam reactant,
b) at least one emission control agent selected from the group consisting of (i) a phosphorous containing group; (ii) a thiocarbamate; (iii) a nitrogen containing compound; (iv) a phenolic antioxidant; or a combination of two or more thereof; and
c) a catalyst.

2. The composition of claim 1, wherein the at least one emission control agent comprise the phosphor containing group (i) selected from a phosphite triester, diorganophosphite, organodiphosphites, a polyolefin having a phosphite substituent, or a phosphonate having a CH or CH₂ moiety attached to phosphorous.

3. The composition of claim 1, wherein the at least one emission control agent is selected from one or more of a compound of Formula (V-i), (V-ii), (V-iii); (V-iv), (V-v), and/or (V-vi): 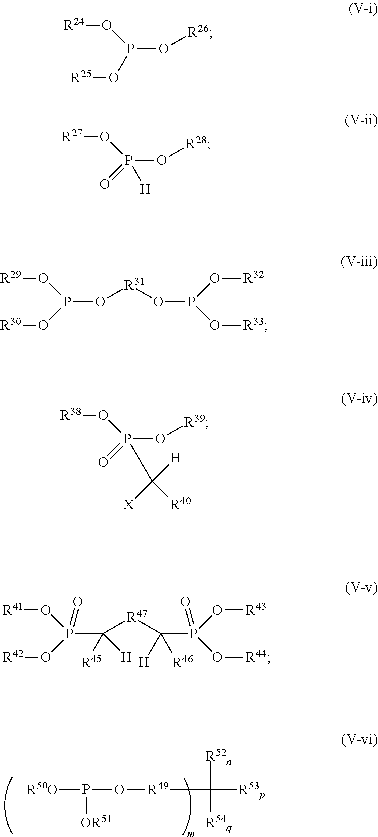
where R²⁴, R²⁵, R²⁶, R²⁷, R²⁸, R²⁹, R³⁰, R³², R³³, R³⁸, R³⁹, R⁴¹, R⁴², R⁴³, R⁴⁴, R⁵⁰, and R⁵¹ are each independently selected from a monovalent C1-C30 alkyl, a C2-C30 alkene comprising one or more points of unsaturation, a C4-C30 cycloalkyl, a C2-C30 ether group a C2-C30 alkylene glycol, a C2-C30 polyalkylene glycol, a C6-C30 aryl, a C7-C30 arylalkyl, and a C7-C30 alkylaryl;
R³¹, R⁴⁷, and R⁴⁹ are each independently selected from a C1-C30 alkylene, a C4-C30 cycloalkylene, a C6-C30 arylene, a C7-C30 arylalkylene, and a C7-C30 alkylarylene;
R⁴⁰, R⁴⁵, R⁴⁶, R⁵², R⁵³, and R⁵⁴ are each independently selected from hydrogen, a monovalent C1-C30 alkyl, a C2-C30 alkene comprising one or more points of unsaturation, a C4-C30 cycloalkyl, a C2-C30 ether group, a C6-C30 aryl, a C7-C30 arylalkyl, and a C7-C30 alkylaryl; and
X is C(O)—R⁴⁸, a C1-C30 alkyl, a C6-C30 aryl optionally substituted with a cyano, OH, where R⁴⁸ is selected from a C1-C30 alkyl.

4. (canceled)

5. (canceled)

6. (canceled)

7. (canceled)

8. (canceled)

9. The composition of claim 1, wherein the emission control agent is selected from one or more of 4,4′-bis(diethylphosphonomethyl) biphenyl, diethyl-4-cyano benzyl phosphonate, N-methoxy-N-methyl(triphenylphosphoranylidene) acetamide, dimethyl(2-oxopropyl)phosphonate, diethyl(2-oxopropyl)phosphonate, dimethyl(2-oxoheptyl)phosphonate, diethyl(2-oxoheptyl)phosphonate, diethyl carboxymethylphosphonate, diethyl(2-oxo-2-phenylethyl)phosphonate, diethyl(methylthiomethyl)phosphonate, methyl (triphenylphosphoranylidene) acetate, diethylphosphonoacetic acid, and 9,10-dihydro-9-oxo-10-phosphophenanthrene-10-oxide.

10. The composition of claim 3, wherein the emission control agent comprises a phosphite triester of the formula: 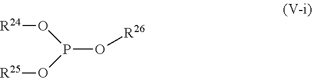
where (a) R²⁴, R²⁵ and R²⁶ are each a C1-C30 alkyl; (b) R²⁴, R²⁵, and R²⁶ are each a C6-C30 aryl, a C7-C30 arylalkyl, or a C7-C30 alkylaryl; or (c) R²⁴, R²⁵ and R²⁶ are each a C2-C30 alkylene glycol or C2-C30 polyalkylene glycol.

11. The composition of claim 10, wherein R²⁴, R²⁵, and R²⁶ are selected from methyl, ethyl, propyl, isopropyl, butyl, isobutyl, tertbutyl, pentyl, isopentyl, hexyl, isohexyl, heptyl, isoheptyl, ocytl, isooctyl, nonyl, decyl, isodecyl, dodecyl, isododecyl, tridecyl, isotridecyl, lauryl, and 2-ethylhexyl.

12. (canceled)

13. The composition of claim 1012, wherein R²⁴, R²⁵, and R²⁶ are selected from phenyl, tosyl, methylphenyl, 6-tertbutyl-3-methylphenyl.

14. (canceled)

15. The composition of claim 1044, wherein R²⁴, R²⁵ and R²⁶ are each selected from ethylene glycol, propylene glycol, diethylene glycol, dipropylene glycol, triethylene glycol, or tripropylene glycol.

16. The composition of claim 3, wherein the emission control agent comprises a diorganophosphite of the formula (V-ii) or its tautomeric form (R²⁷O)P(OH)(OR²⁸): 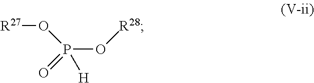
wherein R²⁷ and R²⁶ are each independently selected from a C1-C10 alkyl, and a C6-C30 aryl.

17. The composition of claim 3, wherein the emission control agent comprises an organodiphosphite of the formula (V-iii): 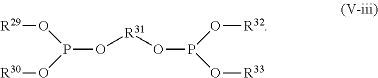
wherein R²⁹, R³⁰, R³², and R³³ are selected from a monovalent C1-C30 alkyl or a C2-C30 ether group, a C2-C30 alkene comprising one or more points of unsaturation, a C6-C30 aryl, a C7-C30 arylalkyl, and a C7-C30 alkylaryl; and
R³¹ is selected from a C1-C30 alkylene, a divalent C2-C30 ether containing group, a C4-C30 cycloalkylene, a C6-C30 arylene, a C7-C30 arylalkylene, and a C7-C30 alkylarylene.

18. The composition of claim 1, wherein the emission control agent is selected from alkylphenol di-isodecyl phosphite, dimethyl phosphite, triethyl phosphite, diphenyl phosphite, triphenyl phosphite, isodecyl diphenyl phosphite, 2-ethylhexyl diphenyl phosphite, disodecyl phenyl phosphite, tris(nonylphenyl)phosphite, tetraphenyl dipropyleneglycol diphosphate, poly (dipropyleneglycol) phenyl phosphite, triisooctyl phosphite, trilauryl phosphite, triisodecyl phosphite, tristridecyl phosphite, triisotridecyl phosphite, phosphonic acid di-9-octadecen-1-yl ester, 4,4′-butylidenebis(6-tert-butyl-3-methylphenyl ditridecyl phosphite), tris(dipropylene glycol)phosphite and diisodecyl phenyl phoshpite, or a combination of two or more thereof.

19. (canceled)

20. The composition of claim 119, wherein the emission control agent comprises a_thiocarbamate is selected from tetramethylthiuram disulfide, tetraethylthiuram disulfide, tetrapropylthiuram disulfide, tetrabutylthiuram disulfide, tetradecylthiruam disulfide, tetrahexadecylthiuram disulfide, tetracicosylthiuram disulfide, 1-methyl-1-propyl-6-butyl-6-methyl thiuram disulfide, 1-propyl-1-butyl-6-methyl-6-t-butyl thiuram disulfide, dihexamethylene thiuram disulfide, dipentamethylene thiuram disulfide, tetrabenzylthiuram disulfide, piperidinium pentamethylene dithiocarbamate, piperidinium dibutyl dithiocarbamate, piperidinium dicyclohexyl dithiocarbamate, piperidinium di(3-oxycyclohexyl) dithiocarbamate, ammonium dipropyldithiocarbamate, metal thiocarbamates as for example, nickel dipropyldithiocarbamate, nickel dibutyldithiocarbamate, nickel didecyldithiocarbamate, zinc dimethyldithiocarbamate, zinc diethyldithiocarbamate, zinc dibutyldithiocarbamate, zinc dihexyldithiocarbamate, zinc dibenzyldithiocarbamate, sodium dimethyldithiocarbamate, sodium diethyldithiocarbamate, sodium dibutyldithiocarbamate, sodium dibenzyldithiocarbamate, copper dimethyl dithiocarbamate, copper dibutyldithiocarbamate, copper diethyldithiocarbamate, copper diamyldithiocarbamate, copper dioctadecyldithiocarbamate, copper diphenyldithiocarbamate, copper dibenzyldithiocarbamate, copper di(orthotolylaminoethyl) dithiocarbamate, copper dicyclohexyldithiocarbamate, potassium dihexyldithiocarbamate, calcium dihexyldithiocarbamate, zirconium diethyldithiocarbamate, tellurium diethyldithiocarbamate, cobalt dibutyldithiocarbamate, antimony dibutyldithiocarbamate, bismuth dimethyldithiocarbamate, lead dimethyldithiocarbamate, tin dibutyldithiocarbamate, copper dicyclopentyldithiocarbamate, copper 1-butyl-1-cyclohexyl-7-butyl-7-cyclohexyl dithiocarbamate, copper di(3-oxacyclohexyl) dithiocarbamate, copper di(4-oxacyclohexyl) dithiocarbamate, copper di(3-thiocyclohexyl) dithiocarbamate, copper di(4-azacyclohexyl) dithiocarbamate, copper 1-butyl-1-(3-oxacyclohexyl)-7-butyl-7-(3-oxacyclohexyl) dithiocarbamate, copper di(4-pyridyl) dithiocarbamate, copper di(4-N,N-dimethyl anilino) dithiocarbamate, copper di(4-anisyl) dithiocarbamate, copper di(4-thioanisyl) dithiocarbamate, and copper di(3-furanyl) dithiocarbamate.

21. (canceled)

22. (canceled)

23. (canceled)

24. (canceled)

25. (canceled)

26. (canceled)

27. (canceled)

28. (canceled)

29. The composition of claim 1, wherein the emission control agent is present in an amount of from about 0.05 part per hundred parts polyol to about 10 parts per hundred parts polyol.

30. The composition of claim 1, wherein the emission control agent is provided as an individual component; and/or wherein the emission control agent is provided as a mixture with the catalyst, water, plasticizer, natural oils, glycols, chain extenders, alkoxylated monoalcohols.

31. (canceled)

32. The composition of claim 1, wherein the at least one foam reactant is selected from a (i) an isocyanate and (ii) a polyether polyol, a polyester polyol, a polyamine, a polyether amine.

33. The composition of claim 29, wherein the emission control agent is provided as a mixture with the isocyanate and/or as a mixture with the polyether polyol, polyamine, and/or polyester polyol.

34. (canceled)

35. A polyurethane foam formed from a mixture of foam forming reactants wherein at least one foam forming reacting is selected from the composition of claim 1, wherein the foam has a concentration of at least one aldehyde species less than that of a foam formed from the same composition in the absence of the emission control agent.

36. The polyurethane foam of claim 35, wherein the foam has a concentration of at least one aldehyde species that is at least 10% to 99.5% lower than that of a foam formed from the same composition without the emission control agent.

37. (canceled)

38. A method for reducing emission from a polyurethane foam, the method comprising contacting at least one foam reactant with at least one emission control agent selected from the group consisting of at least one emission control agent selected from the group consisting of (i) a phosphorous containing group; (ii) a thiocarbamate; (iii) a phenolic antioxidant; or a combination of two or more thereof.

39. The method of claim 38, wherein the at least one emission control agent comprise the phosphor containing group (i) selected from a phosphite triester, diorganophosphite, organodiphosphites, a polyolefin having a phosphite substituent, or a phosphonate having a CH or CH₂ moiety attached to phosphorous.

40. The method of claim 38, wherein the at least one emission control agent is selected from one or more of a compound of Formula (V-i), (V-ii), (V-iii), (V-iv), (V-v), and/or (V-vi): 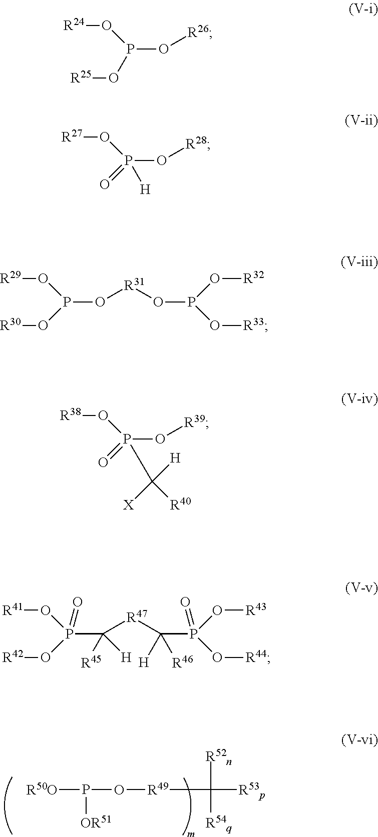
where R²⁴, R²⁵, R²⁶, R²⁷, R²⁸, R²⁹, R³⁰, R³², R³³, R³⁸, R³⁹, R⁴¹, R⁴², R⁴³, R⁴⁴, R⁵⁰, and R$1 are each independently selected from a monovalent C1-C30 alkyl, a C2-C30 alkene comprising one or more points of unsaturation, a C4-C30 cycloalkyl, a C2-C30 ether group a C2-C30 alkylene glycol, a C2-C30 polyalkylene glycol, a C6-C30 aryl, a C7-C30 arylalkyl, and a C7-C30 alkylaryl;
R³¹, R⁴⁷, and R⁴⁹ are each independently selected from a C1-C30 alkylene, a C4-C30 cycloalkylene, a C6-C30 arylene, a C7-C30 arylalkylene, and a C7-C30 alkylarylene;
R⁴⁰, R⁴⁵, R⁴⁶, R⁵², R⁵³, and R⁵⁴ are each independently selected from hydrogen, a monovalent C1-C30 alkyl, a C2-C30 alkene comprising one or more points of unsaturation, a C4-C30 cycloalkyl, a C2-C30 ether group, a C6-C30 aryl, a C7-C30 arylalkyl, and a C7-C30 alkylaryl; and
X is C(O)—R⁴⁸, a C1-C30 alkyl, a C6-C30 aryl optionally substituted with a cyano, OH, where R⁴⁸ is selected from a C1-C30 alkyl.

41. (canceled)

42. (canceled)

43. (canceled)

44. (canceled)

45. (canceled)

46. The method of claim 38, wherein the emission control agent is selected from one or more of 4,4′-bis(diethylphosphonomethyl) biphenyl, diethyl-4-cyano benzyl phosphonate, N-methoxy-N-methyl(triphenylphosphoranylidene) acetamide, dimethyl(2-oxopropyl)phosphonate, diethyl(2-oxopropyl)phosphonate, dimethyl(2-oxoheptyl)phosphonate, diethyl(2-oxoheptyl)phosphonate, diethyl carboxymethylphosphonate, diethyl(2-oxo-2-phenylethyl)phosphonate, diethyl(methylthiomethyl)phosphonate, methyl (triphenylphosphoranylidene) acetate, diethylphosphonoacetic acid, and 9,10-dihydro-9-oxo-10-phosphophenanthrene-10-oxide.

47. The method of claim 40, wherein the emission control agent comprises a phosphite triester of the formula: 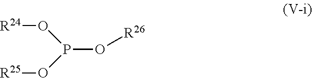
where (a) R²⁴, R²⁵, and R²⁶ are each a C1-C30 alkyl; (b) R²⁴, R²⁵, and R²⁶ are each a C6-C30 aryl, a C7-C30 arylalkyl, or a C7-C30 alkylaryl; or (c) R²⁴ R²⁵ and R²⁶ are each a C2-C30 alkylene glycol or C2-C30 polyalkylene glycol.

48. The method of claim 47, wherein R²⁴, R²⁵, and R²⁶ are selected from methyl, ethyl, propyl, isopropyl, butyl, isobutyl, tertbutyl, pentyl, isopentyl, hexyl, isohexyl, heptyl, isoheptyl, ocytl, isooctyl, nonyl, decyl, isodecyl, dodecyl, isododecyl, tridecyl, isotridecyl, lauryl, and 2-ethylhexyl.

49. (canceled)

50. The method of claim 4749, wherein R²⁴, R²⁵, and R²⁶ are selected from phenyl, tosyl, methylphenyl, 6-tertbutyl-3-methylphenyl.

51. (canceled)

52. The composition of claim 4751, wherein R²⁴, R²⁵ and R²⁶ are each selected from ethylene glycol, propylene glycol, diethylene glycol, dipropylene glycol, triethylene glycol, or tripropylene glycol.

53. The method of claim 40, wherein the emission control agent comprises a diorganophosphite of the formula (V-ii) or its tautomeric form (R²⁷O)P(OH)(OR²⁸): 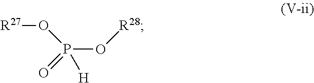
wherein R²⁷ and R²⁶ are each independently selected from a C1-C10 alkyl, and a C6-C30 aryl.

54. The method of claim 40, wherein the emission control agent comprises an organodiphopshite of the formula (V-iii): 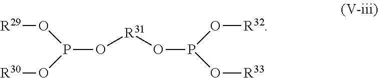
wherein R²⁹, R³⁰, R³², and R³³ are selected from a monovalent C1-C30 alkyl or a C2-C30 ether group, a C2-C30 alkene comprising one or more points of unsaturation, a C6-C30 aryl, a C7-C30 arylalkyl, and a C7-C30 alkylaryl; and
R³¹ is selected from a C1-C30 alkylene, a divalent C2-C30 ether containing group, a C4-C30 cycloalkylene, a C6-C30 arylene, a C7-C30 arylalkylene, and a C7-C30 alkylarylene.

55. The method of claim 40, wherein the emission control agent is selected from alkylphenol di-isodecyl phosphite, dimethyl phosphite, triethyl phosphite, diphenyl phosphite, triphenyl phosphite, isodecyl diphenyl phosphite, 2-ethylhexyl diphenyl phosphite, disodecyl phenyl phosphite, tris(nonylphenyl)phosphite, tetraphenyl dipropyleneglycol diphosphate, poly (dipropyleneglycol) phenyl phosphite, triisooctyl phosphite, trilauryl phosphite, triisodecyl phosphite, tristridecyl phosphite, triisotridecyl phosphite, phosphonic acid di-9-octadecen-1-yl ester, 4,4′-butylidenebis(6-tert-butyl-3-methylphenyl ditridecyl phosphite), tris(dipropylene glycol)phosphite and diisodecyl phenyl phoshpite, or a combination of two or more thereof.

56. (canceled)

57. The method of claim 3856, wherein the emission control agent is a thiocarbamate selected from tetramethylthiuram disulfide, tetraethylthiuram disulfide, tetrapropylthiuram tetrabutylthiuram disulfide, tetradecylthiruam disulfide, tetrahexadecylthiuram disulfide, tetracicosylthiuram disulfide, 1-methyl-1-propyl-6-butyl-6-methyl thiuram disulfide, 1-propyl-1-butyl-6-methyl-6-t-butyl thiuram disulfide, dihexamethylene thiuram disulfide, dipentamethylene thiuram disulfide, tetrabenzylthiuram disulfide, piperidinium pentamethylene dithiocarbamate, piperidinium dibutyl dithiocarbamate, piperidinium dicyclohexyl dithiocarbamate, piperidinium di(3-oxycyclohexyl) dithiocarbamate, ammonium dipropyldithiocarbamate, metal thiocarbamates as for example, nickel dipropyldithiocarbamate, nickel dibutyldithiocarbamate, nickel didecyldithiocarbamate, zinc dimethyldithiocarbamate, zinc diethyldithiocarbamate, zinc dibutyldithiocarbamate, zinc dihexyldithiocarbamate, zinc dibenzyldithiocarbamate, sodium dimethyldithiocarbamate, sodium diethyldithiocarbamate, sodium dibutyldithiocarbamate, sodium dibenzyldithiocarbamate, copper dimethyl dithiocarbamate, copper dibutyldithiocarbamate, copper diethyldithiocarbamate, copper diamyldithiocarbamate, copper dioctadecyldithiocarbamate, copper diphenyldithiocarbamate, copper dibenzyldithiocarbamate, copper di(orthotolylaminoethyl) dithiocarbamate, copper dicyclohexyldithiocarbamate, potassium dihexyldithiocarbamate, calcium dihexyldithiocarbamate, zirconium diethyldithiocarbamate, tellurium diethyldithiocarbamate, cobalt dibutyldithiocarbamate, antimony dibutyldithiocarbamate, bismuth dimethyldithiocarbamate, lead dimethyldithiocarbamate, tin dibutyldithiocarbamate, copper dicyclopentyldithiocarbamate, copper 1-butyl-1-cyclohexyl-7-butyl-7-cyclohexyl dithiocarbamate, copper di(3-oxacyclohexyl) dithiocarbamate, copper di(4-oxacyclohexyl) dithiocarbamate, copper di(3-thiocyclohexyl) dithiocarbamate, copper di(4-azacyclohexyl) dithiocarbamate, copper 1-butyl-1-(3-oxacyclohexyl)-7-butyl-7-(3-oxacyclohexyl) dithiocarbamate, copper di(4-pyridyl) dithiocarbamate, copper di(4-N,N-dimethyl anilino) dithiocarbamate, copper di(4-anisyl) dithiocarbamate, copper di(4-thioanisyl) dithiocarbamate, and copper di(3-furanyl) dithiocarbamate.

58. (canceled)

59. (canceled)

60. (canceled)

61. (canceled)

62. (canceled)

63. (canceled)

64. The method of claim 40, wherein the emission control agent is selected from an alkaline earth metal salt of an alkylphenolthioester, a sulfurized alkyl phenol, a metal salt of a sulfurized alkylphenol, a metal salt of a nonsulfurized alkylphenol, an oil soluble phenate, and a sulfurized phenate.

65. (canceled)
